(19) United States
(12) Patent Application Publication
(10) Pub. No.: US 2019/0179509 A1
(43) Pub. Date: Jun. 13, 2019

(54) SYSTEMS, DEVICES, AND METHODS FOR AUGMENTED REALITY

(71) Applicant: Aurelius, Inc., New York, NY (US)

(72) Inventors: Arman Ari Daie, New York, NY (US); Himanshu Kothari, New York, NY (US); Nitin Dhar, New York, NY (US); Roman Gun, Brooklyn, NY (US)

(21) Appl. No.: 16/218,765

(22) Filed: Dec. 13, 2018

Related U.S. Application Data
(60) Provisional application No. 62/598,311, filed on Dec. 13, 2017.
(60) Provisional application No. 62/598,316, filed on Dec. 13, 2017.
(60) Provisional application No. 62/598,318, filed on Dec. 13, 2017.
(60) Provisional application No. 62/598,320, filed on Dec. 13, 2017.
(60) Provisional application No. 62/598,322, filed on Dec. 13, 2017.
(60) Provisional application No. 62/598,324, filed on Dec. 13, 2017.
(60) Provisional application No. 62/598,325, filed on Dec. 13, 2017.
(60) Provisional application No. 62/598,330, filed on Dec. 13, 2017.
(60) Provisional application No. 62/598,335, filed on Dec. 13, 2017.
(60) Provisional application No. 62/598,336, filed on Dec. 13, 2017.
(60) Provisional application No. 62/598,337, filed on Dec. 13, 2017.
(60) Provisional application No. 62/598,340, filed on Dec. 13, 2017.

(51) Int. Cl. G06F 3/0481; G06F 3/0485; G06F 3/0484; G06F 3/0488; G06T 19/00

(52) U.S. Cl. CPC G06F 3/04815; G06F 3/0485; G06T 19/006; G06F 3/0488; G06F 3/04842

(57) ABSTRACT

The systems, devices, and methods described herein include an inventive user interface including a combination of linear and non-linear data content access. The user interface may display a first portion a content map including content objects and digital content associated with said content objects, receive a user input, and communicate with a processor. In response to the user input and/or processor instructions, the user interface may display a second portion of the content map with associated content objects and digital content. The systems described herein may comprise a memory configured to store the content map and/or digital content and a communications module configured to communicate with at least one content server via a data network. The processor may be arranged to control operations of the memory, communications module, and user interface, and instruct the user interface to display portions of the content map and digital content.

### REFERENCE TO RELATED APPLICATIONS

This application claims priority to and the benefit of U.S. Provisional Patent Application No. 62/598,311, filed on Dec. 13, 2017, and entitled “METHOD FOR CONTENT PLACEMENT ALGORITHM IN THREE-DIMENSIONAL SPACE”, U.S. Provisional Patent Application No. 62/598,316, filed on Dec. 13, 2017, and entitled “DRAG-AND-DROP IN THREE DIMENSIONS”, U.S. Provisional Patent Application No. 62/598,318, filed on Dec. 13, 2017, and entitled “GEO LOCKED STYLE TRANSFER FOR IMAGE, VIDEO AND AUDIO”, U.S. Provisional Patent Application No. 62/598,320, filed on Dec. 13, 2017, and entitled “RTMP AND HLS BASED LIVE TRANSMISSION OF VIDEO, AUDIO, VR AND AR STREAMS WITH APPLIED STYLE TRANSFER”, U.S. Provisional Patent Application No. 62/598,322, filed on Dec. 13, 2017, and entitled “MOBILE HOVER OVER: A SYSTEM FOR GENERATING HOVER STATES VIA A CURSOR”, U.S. Provisional Patent Application No. 62/598,324, filed on Dec. 13, 2017, and entitled “NON-LINEAR GEO BASED CONTENT DISCOVERY”, U.S. Provisional Patent Application No. 62/598,325, filed on Dec. 13, 2017, and entitled “PEER IN PREVIEW (PIP)—METHOD FOR PREVIEWING AND ELABORATING CONTENT ACTIVATED VIA MOBILE HOVER OVER”, U.S. Provisional Patent Application No. 62/598,330, filed on Dec. 13, 2017, and entitled “A PINCH-GESTURE BASED MOVEMENT CONTROL WITHIN A DIGITAL ENVIRONMENT MAPPED OVER PHYSICAL SPACE”, U.S. Provisional Patent Application No. 62/598,335, filed on Dec. 13, 2017, and entitled “SCALED DIGITAL SOCIAL CAPITAL POINT ACCRUAL AND CONTENT ALTERATION SYSTEM”, U.S. Provisional Patent Application No. 62/598,336, filed on Dec. 13, 2017, and entitled “RAY-CAST BASED CONTENT HOVER OVER STATE IN THREE-DIMENSIONAL SPACE”, U.S. Provisional Patent Application No. 62/598,337, filed on Dec. 13, 2017, and entitled “REAL-TIME P2P INTERACTION WITHIN A VIRTUALLY-MAPPED THREE DIMENSIONAL SPACE THAT CORRESPONDS TO A PHYSICAL LOCATION”, U.S. Provisional Patent Application No. 62/598,340, filed on Dec. 13, 2017, and entitled “SYSTEM AND METHOD FOR DESIGNATING A VIRTUAL SPACE CORRESPONDING TO PHYSICAL COORDINATES”. The entire contents of the above-referenced applications are incorporated herein by reference.

### BACKGROUND

Conventional computing devices typically include graphical user interfaces capable of presenting information to users in a virtual reality (VR) or augmented reality (AR) environment. Augmented reality brings components of the digital world into a person's perception of the real world by enhancing natural environments or situations and offering perceptually enriched experiences. Virtual reality places virtual content in a virtual three-dimensional (3D) space presented to a user via the user interface. Such VR and AR interfaces often create usability and data management problems for users. For example, these data interfaces and systems typically provide linear access to data that is extremely inefficient for users, such as social media users, to access large amounts of data, media content, or data centric applications. Accordingly, there is a need for user interfaces to enable users to more efficiently access digital content, usually in VR and AR environments. Another problem in placing digital content in a virtual 3D space is clipping. Because virtual content does not hold real-world physical qualities such as mass, the virtual content's “surface” can intersect with the surface of other virtual content. Accordingly, there is a need for user interfaces present information reliably and with improved clarity. Furthermore, existing mobile communications devices typically have limited memory to cache and/or store data that is presented via the user interface. For user interfaces presenting large amounts of virtual or other data content, the amount of data storage is often insufficient. Accordingly, there is a need to enable a mobile communications device and/or other local device having limited memory to manage data storage based on the content presented to a user via the user interface.

### SUMMARY

The systems, devices, and methods described herein include an inventive user interface including a combination of linear and non-linear data content access. Data objects are distributed on a content layers that can be panned (or zoomed) via the user interface which enables more efficient access to specific portions/windows of contents. Data objects may include icon, text, thumbnail images, photo, graphical images, and the like. Once a window of content objects is selected, then a cursor may be used to linearly access digital content associated with a particular content object.

To resolve data management problems such as clipping, the systems and methods described herein may fill up the space around the user with the digital content to provide a clipping-free environment. According to the implementations described herein, digital content can be placed in a user's local 3D space. The digital content mapped to real-world space may be distributed to prevent inter-content collisions. For example, the content may be distributed to promote space between content items.

In one aspect, a mobile communications device includes a memory, a communications module, and a user interface. The mobile communications device may be a cell phone, tablet, laptop, or any other suitable computing device. The memory may be random access memory (RAM), read only memory (ROM), flash memory, magnetic computer storage devices, optical disks, hard drives, local memory, remote memory, or any other suitable storage device. In one implementation, the memory is configured to store a content map and stores one or more sets of the digital content where content map includes a plurality of content objects. Each content object may be associated with a set of digital content. The communications module may be configured to communicate with at least one content server via a data network. The communications module may be, for example, an antenna, a transmitter and/or responder, or any other suitable element capable of communication.

The user interface may include a display. In some implementations, the display includes a touch screen. The user interface may be, for example, a touch screen, a set of keys and/or buttons, a voice interface, or any other suitable interface that a user can interact with. The display may be a visual, audio, sensory, or any other suitable display. The user interface may display a first portion of the content map including a first content object and first set of digital content associated with the first content object. The first content object may be displayed in a first location on the displayed first portion of the content map. In some configurations, the user interface is arranged to receive a user input and send the user input to a processor. The user interface may be arranged to, in response to the processor, display a second portion of the content map, the second portion of the content map including a second content object and second set of digital content associated with the second content object. The second content object may be displayed in a second location of the displayed second portion of the content map. The process may control operations of the memory, communications module, and user interface. The processor may receive the user input from the user interface, process the user input, and, in response, instruct the user interface to display the second portion of the content map and second set of digital content.

In some configurations, the user interface displays the content map as a content layer having the plurality of content objects laid over the content layer. In some implementations, the processor, in response to the user input, determines if the second set of digital content is stored in the memory. If not, the processor sends a request, via the communications module, to the at least one content server, to receive the second set of digital content. The processor may receive the second set of digital content via the communications module and store the second set of digital content in the memory for display via the user interface.

In some implementations, the systems and methods described herein enable a second user input to select one or more of the plurality of content objects. The second user input may be via a moveable cursor enabling selection of a content object. The processor may, in response to the second user input, determine if the second set of digital content is stored in the memory. If not, the processor may send a request, via the communications module, to the at least one content server, to receive the second set of digital content. The processor may receive the second set of digital content via the communications module, and store the second set of digital content in the memory for display via the user interface.

In some implementations, the processor, in response to the user input, may determine that the second set of digital content is stored in the memory and instruct the user interface to display the second set of digital content from the memory. The processor may fetch content associated with a data object that is closest to a cursor laid over a displayed portion of the content map. In some configurations, the displayed first portion of the content map includes a portion of the content map proportional to physical dimensions of the display. In some implementations, the first set of digital content and/or the second set of digital content is presented in a region of the display.

In some implementations, the user input includes a panning instruction. The panning instruction may include a user swiping a portion of the display in two-dimensional direction. The displayed second portion of the content map may include one or more content objects within the displayed first portion of the content map. In some implementations, the region of the display includes a picture-in-picture (PIP) window overlaid on the displayed portion of the map content. The user input may include a physical movement of the mobile device. The movement may include movement along a predefined channel from a first predefined location to a predefined content region. The display may be configured to present at least one visual cue to communicate a direction of movement. The visual cues may include text. The visual cues may include an arrow indicating a general direction of movement.

In some implementations, the user input includes instructions to zoom in on the display or instructions to zoom out from the display. The second portion of the content map may be a subset of the first portion of the content map. The second portion of the content map may include the first portion of the content map.

In certain implementations, a portion of the plurality of content objects is arranged in the content map according to a degree of relevance of each content object to one or more other content objects. In certain implementations, a portion of the plurality of content objects is arranged in the content map according to user ranking of each object of the available content objects. In some instances, the first location and second location are positioned in the same location of the display. The content map may include a map overlaid in a display including at least one of augmented reality (AR), virtual reality (VR), three-dimensional (3D) imaging, and/or mixed reality (MR) imaging.

In another aspect, a data content server includes a communications module, a data store, and a processor. The communications module may be arranged to, via a data network, receive a request for a first set of digital content associated with a first content object from a first mobile communications device of a plurality of mobile communication devices. The communications module may send the first set of digital content to the first mobile communications device. In some implementations, the request includes an identifier of the first mobile communications device, a location of the first mobile communications device, and/or an identifier of the first content object.

The data store (e.g., memory) may be arranged to store a plurality of content objects and a plurality of sets of digital content associated with the content objects. In some configurations, each set of the plurality of sets of digital content is associated with at least one of the plurality of content objects. The data store may maintain a list of identifiers of the one or more mobile communications devices authorized to access the content server, a list of identifiers of a plurality of content objects, and/or a table associating each of the content object identifiers with at least one set of digital content of the plurality of sets of digital content. In certain implementations, for each mobile communications device, the data store is arranged to store a content map. The content map may include content objects associated with the first mobile communications device. The content objects associated with the first mobile communications device may be arranged in relation to each other based on a ranking. In some implementations, the ranking is based on a degree of relevance among the content objects, user selection, and/or physical geographic proximity of locations of content objects to a physical location of the first mobile communications device.

In certain configurations, the processor is in communication with the communications module and the data store. The processor may be arranged to process the request for the first set of digital content which may include i) authorizing access by the first mobile communications device to the content server, ii) matching the identifier of the first data object with a stored identifier of the first data object to determine the first set of digital content associated with the first data object, and iii) sending the first set of digital content to the first mobile communications device via the communications module. In some implementations, the processor may authorize access by the first mobile communications device to the content server by matching the identity of the first mobile communications device with one of the authorized mobile communications device identities in the data store. Upon request from the first mobile communications device, the processor may send, via the communications module, the content map associated with the first mobile communications device to the first mobile communications device.

In yet another aspect, a mobile data system may include data network, a content server, and one or more mobile communications devices. The mobile data system may include one or more content servers and one or more mobile communications devices. A first content server may be arranged to store a plurality of content objects and a plurality of sets of digital content associated with the content objects. In certain configurations, each set of the plurality of sets of digital content is associated with at least one of the plurality of content objects. For each of the one or more mobile communications devices, the first content server may be configured or arranged to store a content map. The content map associated with the first mobile communications device may include content objects associated with the first mobile communications device.

In some configurations, the first mobile communications device, being in communication with the first content server via the data network, includes a memory and a user interface having a display. The memory may be arranged to store the content map, the content objects associated with the first mobile communications device, and/or the sets of the digital content associated with the content objects. The user interface may be arranged to i) display a first portion of the content map including a first content object and first set of digital content associated with the first content object, ii) receive a user input and send the user input to a processor, and iii) in response to the processor, display a second portion of the content map. The first content object may be displayed in a first location on the displayed first portion of the content map. The second portion of the content map may include a second content object and second set of digital content associated with the second content object. The second content object may be displayed in a second location of the displayed second portion of the content map. The processor may be further arranged to receive the user input from the user interface, process the user input, and, in response, instruct the user interface to display the second portion of the content map and second set of digital content.

The systems and methods described herein may also show hover states in touch-sensitive systems. In some configurations, the system includes a memory, a database stored in the memory, an interface, and a processor. The database may store computer program instructions. The interface may include a touch-sensitive display and/or a virtual cursor. The virtual cursor may be a graphical, user-interface object representing a pointing device that resides in a virtual layer above an interactive and/or virtual data layer. A user may interact with the data layer by panning the device screen underneath the cursor virtual layer, in order to interact with data. The processor may be coupled to the memory and be operable for executing the instructions to perform operations. Such operations may include, but are not limited to, detecting a contact with the touch-sensitive display at a point; moving the data layer continuously on the touch-sensitive display underneath the cursor layer, in accordance with a user movement, wherein the user movement maintains continuous contact with the touch-sensitive display; and/or triggering, based on the cursor landing on content from the data layer, a hover change state.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 illustrates a device running an augmented reality application and displaying an augmented reality screen shot;

FIG. 2 is a schematic diagram of an example architecture for a mobile device capable of location based network services;

FIG. 3 shows a block diagram of an exemplary Wireless Communications System;

FIG. 4 shows a block diagram of a close up of a mobile device placed relative to 3D content;

FIG. 5 shows a block diagram of a birds eye view of a mobile device placed relative to 3D content;

FIG. 6 shows a flow chart of steps for a peer-in-preview feature;

FIG. 7 shows a block diagram of an anterior view of a peer-in-preview feature;

FIG. 8 shows a flowchart of steps for a mobile hover over feature;

FIG. 9 shows a block diagram of an anterior view of a mobile hover over feature;

FIG. 10 shows a block diagram of a cross-sectional view of a mobile hover over feature;

FIG. 11 shows a flowchart of steps of 3D hover over on a mobile device;

FIG. 12 shows a diagram of 3D hover over on a mobile device;

FIG. 13 shows a flowchart of the steps of dragging and dropping content in 3D;

FIG. 14 shows a diagram of pinch-gesture based movement on a mobile device;

FIG. 15 shows a block diagram of non-linear geography based content discovery;

FIG. 16 shows a schematic diagram of live transmission of video, audio, augmented reality, and virtual reality with style transfer;

FIG. 17 shows a flowchart of geo-locked style transferring of image, video, and audio;

FIG. 18 shows a block diagram of a mobile device with geo-locked style transferring;

FIG. 19 shows a flowchart of steps for binding digital real estate to physical coordinates;

FIG. 20A-C show a block diagram of digital real estate bound to physical coordinates;

FIG. 21 shows a block diagram of real-time person-to-person interaction in a virtual space;

FIG. 22 shows a flowchart of steps for real-time person-to-person interaction in a virtual space; and

FIG. 23 shows a schematic diagram of a digital social capital point system.

### DETAILED DESCRIPTION

To provide an overall understanding of the systems, method, and devices described herein, certain illustrative embodiments will be described. Although the embodiments and features described herein are specifically described for use in connection with augmented reality for mobile communications devices, it will be understood that all the components and other features outlined below may be combined with one another in any suitable manner and may be adapted and applied to other types of interactive devices.

The systems, devices, and methods described herein include an inventive user interface including a combination of linear and non-linear data content access. Data objects are distributed on a content layers that can be panned (or zoomed) via the user interface which enables more efficient access to specific portions/windows of contents. Once a window of content objects is selected, then a cursor is used to linearly access digital content associated with a particular content object.

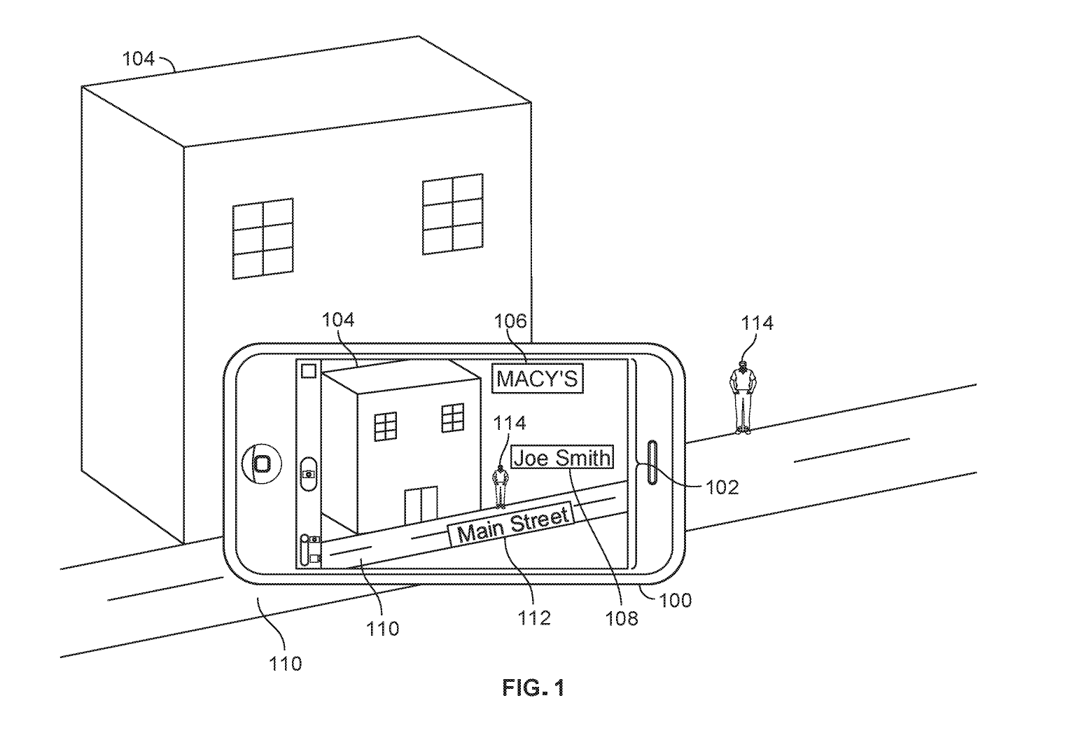

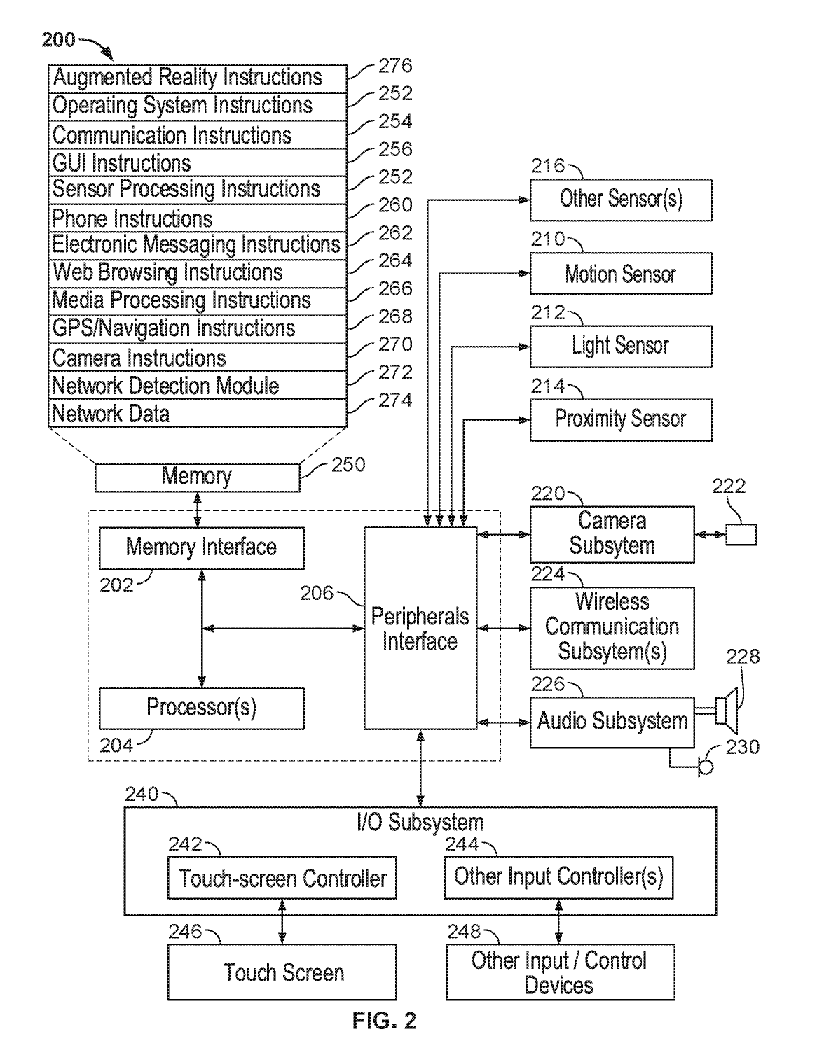

FIG. 1 illustrates a device 100 running an augmented reality application and displaying an augmented reality screenshot as described herein. As illustrated, the device 100 displays an image 102 of department store on Main Street, using its image-capturing camera or optical sensor 222 and display, e.g., touch screen 246. In this way, the display can function as a viewfinder. As illustrated, the image 102 has been augmented with information corresponding to store 104, person 114, and street 110. Various labels are added to and/or overlaid onto the image 102. Store label (“Macy's”) 106 corresponds to store 104; person label (“Joe Smith”) 108 corresponds to person 114, and street label 112 (“Main Street”) corresponds to street 110. Device 100 may be any device capable of determining its current geographic location by communicating with a positioning system, such as GPS, cellular networks, WiFi networks, and any other technology that can be used to provide the actual or estimated location of a device 100. Some examples of devices include but are not limited to: a mobile communications device, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices. Device 100 may comprise a touch-sensitive display and/or touch screen 246, a processor, a memory, a database, and instructions for executing operations. Such a device is described, for example, in FIG. 2 below.

FIG. 1 illustrates a captured and presented image 102 using an image capture device, i.e., the camera of a smart phone, which is but one type of device to which the present disclosure can be applied. Using data that describes the area surrounding the present location of device 100, the points of interest located in the surrounding area, and persons located in that area, device 100 augments the displayed image with additional information. In this instance, device 100 displays names of the locations, described by the data, which are displayed in the viewfinder (such as Macy's 106 and Main Street 112). While other stores, streets, persons, or points of interest might also be nearby, they are not shown because they fall outside the field of view of device 100. However, a user of device 100 could locate these stores by panning device 100 around the area, in which case those points of interest would appear on the screen.

In the image 102, device 100 augments the captured image 102 with bubbles showing the name of “Macy's” 106 within the captured image 102. This allows the user to determine stores near them. A user can then select a point of interest, e.g., by selecting the “Macy's” 106 point of interest information bubble, e.g., by touching the point of interest information bubble with a finger or stylus if the smart phone employs a touch screen. In other implementations, a cursor and mouse can be used to select a desired point of interest. The image 102 may be displayed by the device 100 via a display and/or touch screen 246.

Points of interest can be any feature, but most often a point of interest can be a map feature such as a store, or an identification of a person. For example, a point of interest can be a department store, grocery vendor, marketplace, boutique or other suitable point. Likewise a point of interest can be additional places, buildings, structures, or even friends that can be located on a map (such as through a location-based system in their phone). In some instances, a point of interest is identified as a result of a search. A point of interest can also be a map feature that is identified by the present system because it can be viewed in the image. In short, a point of interest can be any feature, which can be identified through the viewfinder and corresponding data. Any type of feature, image, text, graphics, audio, video or perceptible information may be added and/or overlaid onto the image 102 to form and and/or present an augmented reality image.

FIG. 2 is a schematic diagram 200 of an example architecture for a mobile device, such as device 100 described in relation to FIG. 1, capable of location based network services. The mobile device can include memory interface 202, one or more data processors, image processors and/or central processing units 204, and peripherals interface 206. Memory interface 202, one or more processors 204 and/or peripherals interface 206 can be separate components or can be integrated in one or more integrated circuits. One or more communication buses or signal lines can couple the various components in the device.

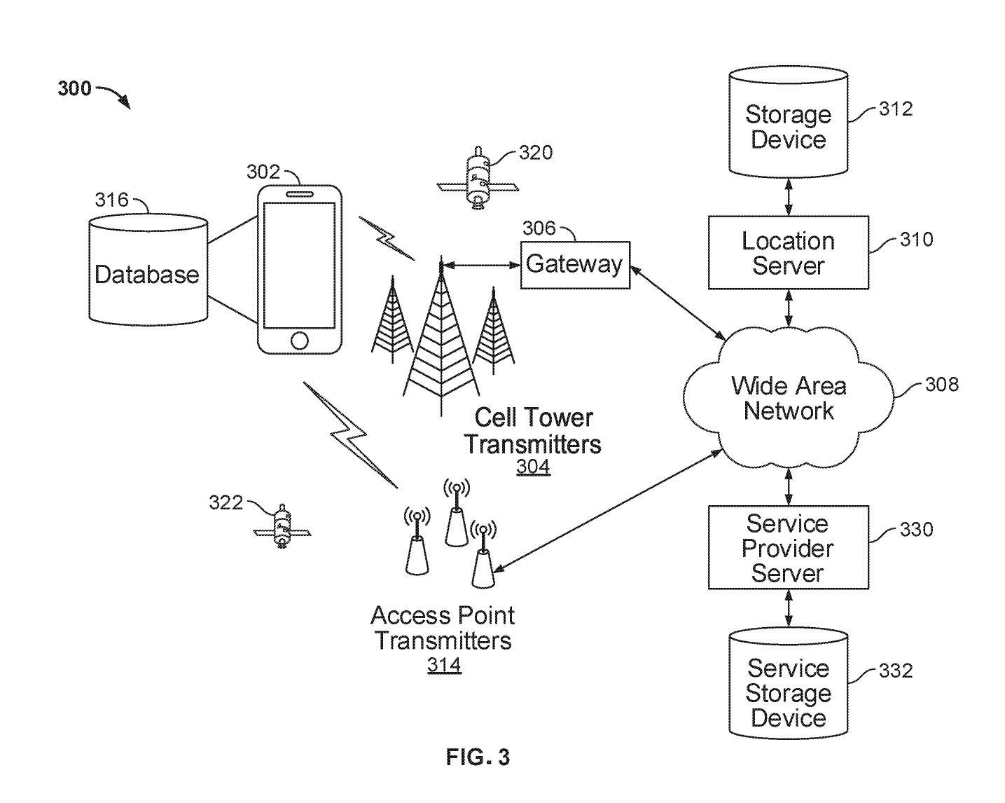

Sensors, devices, and subsystems can be coupled to peripherals interface 206 to facilitate multiple functionalities. For example, motion sensor 210, light sensor 212, proximity sensor 214, position system 278 can be coupled to peripherals interface 206 to facilitate orientation, lighting, proximity, and positioning functions. The position system 278 may be, for example, a GPS receiver, and may provide the functions of a location server, such as that described in reference to FIG. 3. Other sensors 216 can also be connected to peripherals interface 206, such as a temperature sensor, a biometric sensor, magnetic compass, FM or satellite radio, or other sensing device, to facilitate related functionalities.

Camera subsystem 220 and optical sensor 222, e.g., a charged coupled device (CCD) or a complementary metal-oxide semiconductor (CMOS) optical sensor, can be utilized to facilitate camera functions, such as recording photographs and video clips, and viewing areas, as is described above in relation to FIG. 1.

Communication functions can be facilitated through one or more wireless communication subsystems 224, which can include radio frequency receivers and transmitters and/or optical (e.g., infrared) receivers and transmitters. The specific design and implementation of communication subsystem 224 can depend on the communication network(s) over which device 100 is intended to operate. For example, device 100 may include communication subsystems 224 designed to operate over a 5G, network, 4G network, LTE network, CDMA network, GSM network, a GPRS network, an EDGE network, a WiFi or WiMax network, and a Bluetooth™ network. An example of a network over which device 100 may communicate is further described below in relation to FIG. 3. Wireless communication subsystems 224 may also include hosting protocols such that device 100 may be configured as a base station for other wireless devices.

Audio subsystem 226 can be coupled to speaker 228 and microphone 230 to facilitate voice-enabled functions, such as voice recognition, voice replication, digital recording, and telephony functions.

I/O subsystem 240 can include touch screen controller 242 and/or other input controller(s) 244. Touch-screen controller 242 can be coupled to touch screen 246. Touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 246. Touch screen 246 may comprise a touch-sensitive display.

Other input controller(s) 244 can be coupled to other input/control devices 248, such as one or more buttons, rocker switches, thumb-wheel, infrared port, USB port, and/or a pointer device such as a stylus. One or more buttons (not shown) can include an up/down button for volume control of speaker 228 and/or microphone 230.

In one implementation, a pressing of the button for a first duration may disengage a lock of touch screen 246; and a pressing of the button for a second duration that is longer than the first duration may turn power to device 100 on or off. The user may be able to customize a functionality of one or more of the buttons. Touch screen 246 can, for example, also be used to implement virtual or soft buttons and/or a keyboard. In addition to touch screen 246, device 100 can also include a touch pad.

In some implementations, device 100 can present recorded audio and/or video files, such as MP3, AAC, and MPEG files. In some implementations, device 100 can include the functionality of an MP3 player, such as an iPod™. Device 100 may therefore include a connector that is compatible with the iPod™. Other input/output and control devices can also be used.

Memory interface 202 can be coupled to memory 250. Memory 250 can include high-speed random access memory and/or non-volatile memory, such as one or more magnetic disk storage devices, one or more optical storage devices, and/or flash memory (e.g., NAND, NOR). Memory 250 can store an operating system 252, such as Darwin, RTXC, LINUX, UNIX, OS X, WINDOWS, or an embedded operating system such as VxWorks. Operating system 252 may include instructions for handling basic system services and for performing hardware dependent tasks. In some implementations, operating system 252 can be a kernel (e.g., UNIX kernel).

Memory 250 may also store communication instructions 254 to facilitate communicating with one or more additional devices, one or more computers and/or one or more servers. Memory 250 may include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/Navigation instructions 268 to facilitate GPS and navigation-related processes and instructions; camera instructions 270 to facilitate camera-related processes and functions; and network detection module 272; network data 274 to facilitate the processes and functions; and augmented reality instructions 276 to facilitate the processing and display of augmented reality data. Memory 250 may also store other software instructions (not shown), such as web video instructions to facilitate web video-related processes and functions; and/or web shopping instructions to facilitate web shopping-related processes and functions. In some implementations, media processing instructions 266 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 250.

Each of the above identified instructions and applications can correspond to a set of instructions for performing one or more functions described above. These instructions need not be implemented as separate software programs, procedures, or modules. Memory 250 can include additional instructions or fewer instructions. Furthermore, various functions of device 100 may be implemented in hardware and/or in software, including in one or more signal processing and/or application specific integrated circuits.

FIG. 3 is a block diagram of an exemplary Wireless Communications System (WCS) 300. In some implementations, WCS 300 may include mobile device 302, cellular tower transmitters 304, access point transmitters 314 (e.g., WiFi beacons), and location server 310. Mobile device 302 may be device 100, described above in reference to FIGS. 1 and 2. Therefore, mobile device 302 can be any device capable of determining its current geographic location by communicating with a positioning system, such as GPS, cellular networks, WiFi networks, and any other technology that can be used to provide the actual or estimated location of a mobile device 302. Some examples of mobile devices include but are not limited to: a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices. Mobile device 302 can include a storage device (e.g., flash memory, hard disk) for storing database (DB) 316.

Cellular tower transmitters 304 can be coupled to wide area network 308 (e.g., the Internet) through gateway 306, and access point transmitters 314 can be coupled to network 308 through wired and/or wireless communication links and may interact directly or indirectly with mobile device 302.

In some implementations, mobile device 302 may operate on a cellular network including cellular tower transmitter 304. The cellular network may comprise a first cellular network cluster and second cellular network cluster. Each cellular network cluster may contain a controller and a plurality of base stations. Each base station may cover a single cell of the cellular network cluster, and each base station may communicate through a wireless connection with the controller for call processing, as is well known in the art. Wireless devices communicate via the nearest base station (i.e. the cell the device currently resides in). Roaming functionality is provided when a wireless device roams from one cell to another so that a session is properly maintained with proper signal strength. A controller acts like a telephony switch when a wireless device roams across cells, and it communicates with the controller via a wireless connection so that a wireless device can also roam to other clusters over a larger geographical area. A first controller may be connected to a second controller in a cellular cluster through a physical connection, for example, copper wire, optical fiber, or the like. This enables cellular clusters to be great distances from each other. The controller may in fact be connected with a physical connection to its base stations. Base stations may communicate directly with the controller. Base stations may communicate indirectly to the controller, for example through other base stations. It is well known in the art that many options exist for enabling interoperating communications between controllers and base stations for the purpose of managing a cellular network. A cellular network cluster may be located in a different country.

A base controller may communicate with a controller through a Public Service Telephone Network (PSTN) by way of a first telephony switch, a PSTN, and second telephony switch, respectively. The first and second telephony switches may be private or public. In one cellular network embodiment of the present invention, a server-side data processing system executes at the controllers. A receiving data processing system executes at a mobile device 302, for example a mobile laptop computer, wireless telephone, a personal digital assistant (PDA), or the like. As the mobile device 302 moves about, positional attributes are monitored for determining a situational location. The mobile device 302 may be handheld, or installed in a moving vehicle. Locating a mobile device using wireless techniques such as Time Difference of Arrival (TDOA) and Angle Of Arrival (AOA) are well known in the art. The server-side data processing system may also execute on a server computer accessible to controllers, provided an appropriate timely connection exists between cellular network controller(s) and the server computer. Mobile devices may be known by a unique identifier, for example a caller id, device identifier, or like appropriate unique handle.

Locating functionality can be provided to mobile device 302 through local automatic location detection means or by automatic location detection means remote to mobile device 302. Automatic location detection means determines the whereabouts of a device, and examples include GPS (Global Positioning System) chips, GPS accessories, blue-tooth connected GPS, triangulated location determination, cell-tower triangulated location, antenna triangulated location, in-range proximity based location detection, combinations thereof, or by any other automatic location detection means. This disclosure supports any device with GPS functionality regardless of how the GPS functionality is provided to, or for, the device. Many mobile devices may be blue-tooth enabled which provides the ability to adapt GPS locating means to the device. This disclosure also supports proximity location means, which involves a device coming within range of a detecting means for determining a known location. Being within range of the detecting means implies locating the device by associating it to the location of the detecting means. There are various wireless detection methods and implementations well known in the art for knowing when a device comes into range of communications.

In an embodiment of the present invention, GPS satellites such as satellite 320 and satellite 322, provide information, as is well known in the art, to GPS devices on earth for triangulation locating of the GPS device. In this embodiment, a mobile device 302 has integrated GPS functionality so that the mobile device 302 monitors its positional attribute(s). When the mobile device 302 determines a candidate delivery event, it communicates parameters to the controller by way of the nearest base station.

Location server 310 can include one or more server computers operated by a location service provider. Location server 310 can deliver location information to mobile device 302. In some implementations, mobile device 302 collects and stores network information associated with transmitter detection events. The network information can include a transmitter identifier (ID) of a detected transmitter, a timestamp marking a time of the transmitter detection event and a location, if available. Some examples of transmitter IDs include but are not limited to Cell IDs provided by cell tower transmitters 304 in a cellular communications network (e.g., transmitters on GSM masts) and access point transmitter 314 IDs (e.g., a Media Access Control (MAC) address). A wireless access point (AP) (such as that represented by access point transmitters 314) can be a hardware device or a computer's software that acts as a communication hub for users of a wireless device to connect to a wired LAN. Other examples of cellular network information include Mobile Country Code (MCC), Mobile Network Code (MNC) and Location Area Code (LAC).

The transmitter IDs can be correlated with known geographic locations of corresponding transmitters. The geographic locations of the transmitters can be used to compute estimated position coordinates (e.g., latitude, longitude, and altitude) for mobile device 302 over a period of time. For example, a sequence of transmitter IDs can be compared with a reference database (e.g., Cell ID database, WiFi reference database) that maps or correlates the transmitter IDs to position coordinates of corresponding transmitters, and computes estimated position coordinates for mobile device 302 based at least in part on the position coordinates of the corresponding transmitters. If a reference database is available on mobile device 302, then the mapping can be performed by a processor of mobile device 302. Alternatively, the transmitter IDs can be sent to location server 310, which can store transmitter position, coordinates in a remote reference database in storage device 312. Location server 310 can map or correlate transmitter IDs to position coordinates of corresponding transmitters, which can be sent back to mobile device 302 through network 308 and one or more wireless communication links. The position coordinates can be reverse geocoded to map locations (e.g., street locations). The map locations can be represented by markers (e.g., pushpin icons) on a map view displayed by mobile device 302, or used for other purposes by mobile applications. The position coordinates and associated timestamps can be stored in database 316 and/or storage device 312 for subsequent retrieval and processing by a user or application. The position coordinates and timestamps can be used to construct a timeline in a map view showing a history of locations for mobile device 302.

Similarly, service provider server 330 can include one or more server computers operated by a service provider. For example, the service provider may be a clothing vendor, store, or other suitable provider. Service provider server 330 can deliver service information to mobile device 302. Server 330 can provide service and/or product information, which can be sent back to mobile device 302 through network 308 and one or more wireless communication links. In some configurations, server 330 includes information and/or data sent to and/or used by an augmented reality application running augmented reality instructions 276 to present augmented reality information via a display and/or touch screen 246, as illustrated in FIG. 1. In some configurations, the device 100 may function as a client device in a client-server configuration with an augmented reality application running on the server 330 to present augmented reality information, such as illustrated in FIG. 1, via touch screen 246. The available services and/or products may be determined by the location of the mobile device 302 and/or device 100, which may be determined in the manner described above. The services and/or products can be represented by markers (e.g., an image of the products and a link to the service provider website) on a map view displayed by mobile device 302, or used for other purposes by mobile applications. The service and/or product information can be stored in database 316 and/or storage device 332 for subsequent retrieval and processing by a user or application. The services and/or products viewed can be used to construct a history of services for mobile device 302.

A baseband processor in mobile device 302 can be used in a RF subsystem to transmit and receive RF signals in, for example, a 5G (Fifth Generation) mobile service, 4G (Fourth Generation) mobile service, 3G (Third Generation) mobile service, an IMT-Advanced Standard (International Mobile Telecommunications-Advanced) service, an LTE (Long Term Evolution) mobile service, a CDMA (Code Division Multiple Access) mobile service, GSM (Global System for Mobile communications), GPRS (General Packet Radio Service) and EGPRS (Enhanced General Packet Radio Service). During reception of RF signals, the RF subsystem receives RF signals, converts the RF signals into baseband signals and sends the baseband signals to the baseband processor. Thereafter, the baseband processor processes the received baseband signals to decode various data from the baseband signals.

In some implementations, mobile device 302 can store network information (e.g., transmitter IDs) for wireless cellular networks that have communicated with mobile device 302. The network information and location where the communication occurred can be stored in a local database (e.g., database 316) on mobile device 302. When mobile device 302 determines that it is operating at a location previously stored in the database (e.g., determined by matching current GPS location data with stored locations), then the stored network information corresponding to the matched stored location can be used to narrow a search for available wireless cellular networks at the matched location. For example, when mobile device 302 wakes up or exits a mode where wireless access was not available (e.g., an “airplane mode”), the matched location of the mobile device 302 can be used to determine a list of wireless cellular networks that are potentially available for access at the matched location.

In some implementations, location-sorted network information can be pre-stored on mobile device 302 even if mobile device 302 has never been at the matched location.

In some implementations, the list of wireless cellular networks can be searched in order based on one or more characteristics or attributes of the transmission signal. For example, signal strength can be recorded as part of the network information and used to narrow a search to only those wireless cellular networks potentially accessible at the location and that have signal strengths that exceed a certain threshold. In some implementations, the location-sorted network information can include the frequency band and channel information (e.g., for 5G, 4G, 3G, 2G) for each network in the approximate location of the mobile device 302 to significantly reduce network search time even further.

In some implementations where the mobile device is being operated in a new location (no previously stored network information), a broadcast radio system in the device 302 can be used to determine an approximate location of mobile device 302.

Current technology enables devices to communicate with each other, and other systems, through a variety of heterogeneous system and communication methods. Current technology allows executable processing to run on diverse devices and systems. Current technology allows communications between the devices and/or systems over a plethora of methodologies at close or long distance. Many technologies also exist for automatic locating of devices. It is well known how to have an interoperating communications system that includes a plurality of individual systems communicating with each other with one or more protocols. As is further known in the art of developing software, executable processing of the present invention may be developed to run on a particular target data processing system in a particular manner, or customized at install time to execute on a particular data processing system in a particular manner.

The disclosed embodiments relate generally to user interfaces that employ touch-sensitive displays, and more particularly, to the navigation of user interfaces on portable electronic devices. Touch-sensitive displays (also known as “touch screens” or “touchscreens”) are well known in the art. Touch screens are used in many electronic devices to display graphics and text, and to provide a user interface through which a user may interact with the devices. A touch screen detects and responds to contact on the touch screen. A device may display one or more soft keys, menus, and other user-interface objects on the touch screen. A user may interact with the device by contacting the touch screen at locations corresponding to the user-interface objects with which she wishes to interact. Touch screens are becoming more popular for use as displays and as user input devices on portable devices, such as mobile telephones and personal digital assistants (PDAs).

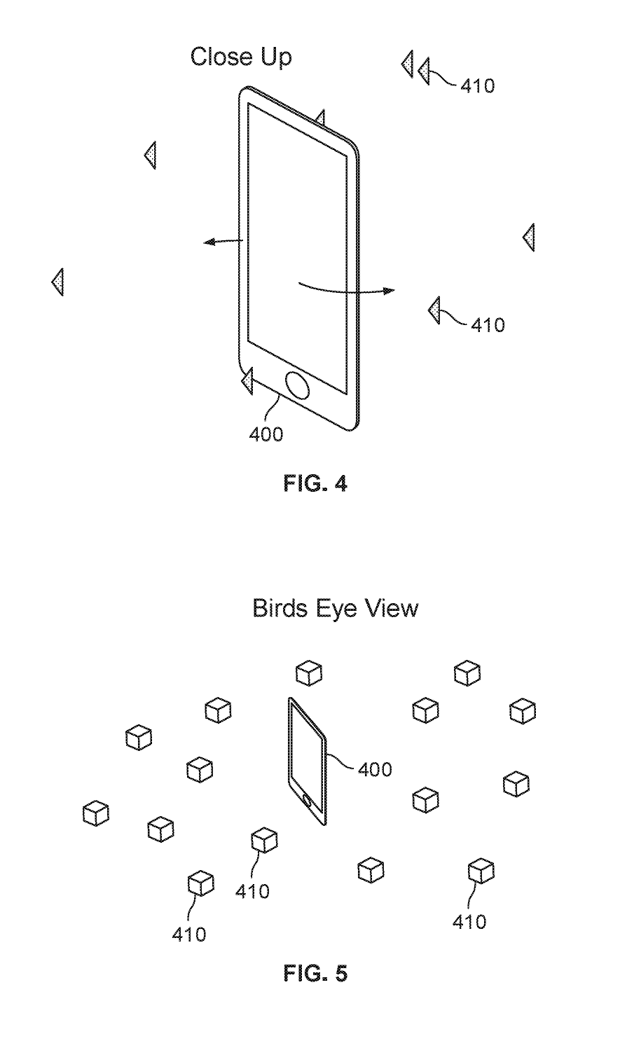

FIG. 4 shows a block diagram of a close up of a mobile device 400 placed relative to 3D content represented by icons 410. FIG. 5 shows a birds eye view of mobile device 400 placed relative to 3D content represented by icons 410. One problem in placing digital content in a virtual 3D space is that clipping occurs. Since digital content (e.g., content represented by icons 410) does not hold real-world physical qualities such as mass, its surface can intersect with the surface of other content. To resolve such clipping, the systems and methods described herein fill up the space around the user with the digital content (e.g., content represented by icons 410) to provide a clipping-free environment. As shown in FIGS. 4-5, digital content represented by icons 410 can be placed in a user's local 3D space, effectively surrounding mobile phone 410. Digital content represented by icons 410 is mapped to real-world space such that icons 410 are distributed to prevent inter-content collisions. In some implementations, content represented by icons 410 may be distributed to promote space between content items. For example, icons 410 may be distributed to maximize space between icons, to randomly distribute icons, to place icons within a given range of one another, or any other suitable distribution.

Mobile device 400 includes a user interface, a memory, a database stored in the memory, and a processor. For example, a mobile phone, tablet, or any other suitable device. In some implementations, a server may place digital content represented by icons 410 in a virtual 3D space; mobile device 400 may access the digital content placed by the server. In some implementations, the memory, database, or both may be located remotely from the mobile device. The database stores computer program instructions. The interface of mobile device 400 includes a display, which is configured to display digital content. For example, a user may view the digital content on the display and interact with said content. In some implementations, mobile device 400 may comprise a touch-sensitive display screen. The processor is coupled to the memory. The processor may be operable for executing the instructions to perform operations. Such operations may include, but are not limited to, establishing a 3D virtual space with an origin point in a certain frame of reference, for example based on placement of mobile device 400. Other example operations include tracking the movement of the mobile-device and representing said movement in this space by a virtual point-of-view and moving the mobile-device continuously, in accordance with user movement, wherein the user movement triggers movement of the virtual point-of-view, thus displaying digital content placed in the virtual space on the screen of mobile device 400.

In some implementations, the digital content represented by icons 410 may be positioned anywhere around the virtual 3Dimensions of the point-of-view without allowing collisions between virtual geometries of said content. In some implementations, digital content geometries may collide, forming connections or groupings representing a composite piece of content. In some implementations, content may be separated by a non-zero minimum distance to simulate a uniform random placement. In other implementations, content may have minimum and maximum distance constraints. Digital content may display distance from point-of-view in virtual space. The distance may be mapped to a real world distance between the user holding the mobile device (which represents the virtual point-of-view) and the virtual content.

In some implementations, content's virtual size can be mapped to real-world space. In some implementations, the content is distributed over space mapped in the real world such that collisions or clustering do not occur. In some implementations, content is manually placed in a 3D space by means of mouse and keyboard. In some implementations, on a touch device, the content is long-pressed and placed. In some implementations, the content is tapped and placed. In some implementations, the content is hard pressed and placed. In some implementations, the content is flicked or swiped to be placed. In some implementations, on a touch device, the content is spun to rotate in placed position.

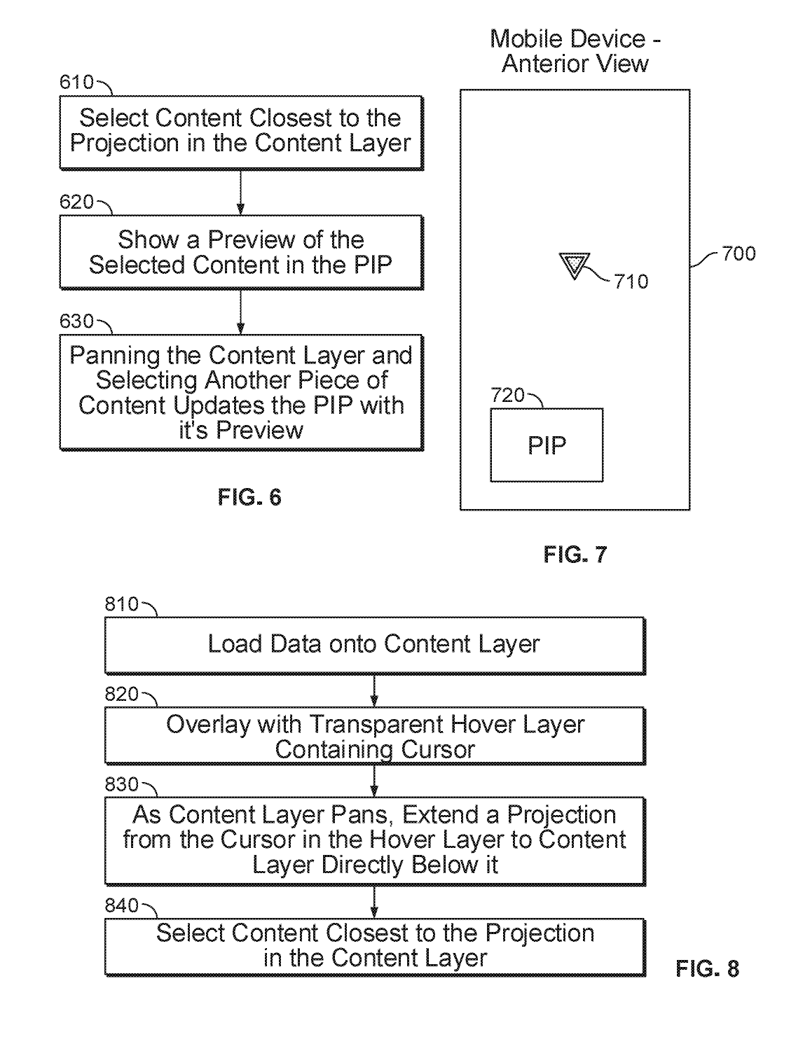

FIG. 6 shows a flow chart of steps for a peer-in-preview feature. FIG. 7 shows a block diagram of an anterior view of a system displaying the peer-in-preview feature on an interface 700. One problem associated with using touch screens on portable devices is the nesting of content and the breakage of the “Three Click Rule”. Due to the nature of current mobile device interfaces, it is considerably more difficult to avoid nesting content, and thus rearing the need for many clicks to access content. A hover-over-based content preview generation system, such as the peer-in-preview (PIP) component described herein, alleviates many design and user interface challenges.

At step 610 of FIG. 6, a user selects content closest to the projection in the content layer displayed on a mobile device display (e.g., display 700). At step 620, the display then shows a preview of the selected content in the PIP. At step 630, a user then pans the content layer and selects another piece of content. The display then updates the PIP to reflect the selected piece of content.

Display 700 is navigated using a cursor-based interface in conjunction with swipe gestures. Cursor 710 moves as a user swipes the display with his or her finger. When cursor 710 lands on content, the mobile device generates a preview 720 of the content that cursor 710 landed on. In some implementations, the preview 720 may be generated in a separate modal display (e.g., a new window shown on display 700). The generated preview 720 may include either audio, video, text or any combination thereof. The generated preview 720 includes a visual display of digital content triggered by a mobile hover-over system in a non-linear data discovery layer. In some implementations, the device including display 700 is a mobile device, for example, a mobile phone, tablet, or any other suitable device. In some implementations, the display is a touch-sensitive user interface, with which a user views digital content on and interacts with said content. The system includes a memory, a database stored in the memory, and a processor. The database stores computer program instructions. The processor is coupled to the memory. The processor may be operable for executing the instructions to perform operations. Such operations may include, but are not limited to, tracking digital content in the hover state and updating the display of the peer-in-preview user interface component.

In some implementations, the PIP visibility may be controlled by a selection or hover state on some digital content. In some implementations, the PIP may be responsive to contacts on the touch screen display. If a touch is detected in the bounds of the PIP, an action may be triggered as a result. Actions may lead to appropriate visual cues such as displaying content details, expansion of the PIP to cover the entire screen, or other suitable visual results. In some implementations, the PIP may respond to “long presses”, that is, continued user contact with the display screen by re-setting the origin point of the point (the middle) of the PIP interface component to the detected touch-point. In some implementations, the PIP is over a batch or series of clustered points. In some implementations, the PIP is accessed by means of pinch-to-zoom.

FIG. 8 shows a flowchart of steps for a mobile hover over feature. One problem associated with using touch screens on portable devices is the lack of a hover state. Hover states or change states on desktops are one of the most vital visual cues on can give to a user that an item, video, image or any other common content type is intractable with. Thus, portable devices, touch screens on such devices, and/or applications running on such devices may be a subpar user experience as compared to desktop-based interfaces; and as such mobile-based hover over states meet a long-felt but unmet need. According to the systems and methods described here, a device with a touch-sensitive display may be navigated using a cursor-based interface in conjunction with swipe gestures. The cursor moves as a user swipes the display with his or her finger.

At step 810, data is loaded onto a content player. At step 820, the content layer is overlaid with a transparent hover layer having a cursor. The cursor, when landing on content, activates a hover state or otherwise to be named change state. At step 830, as the content layer is panned, a projection is extended from the cursor in the hover layer to content in the content layer below the hover layer, entering a “hover state”. The hover state alters the visual appearance of the content to mimicry activation. At step 840, the content closest to the projection in the content layer is selected.

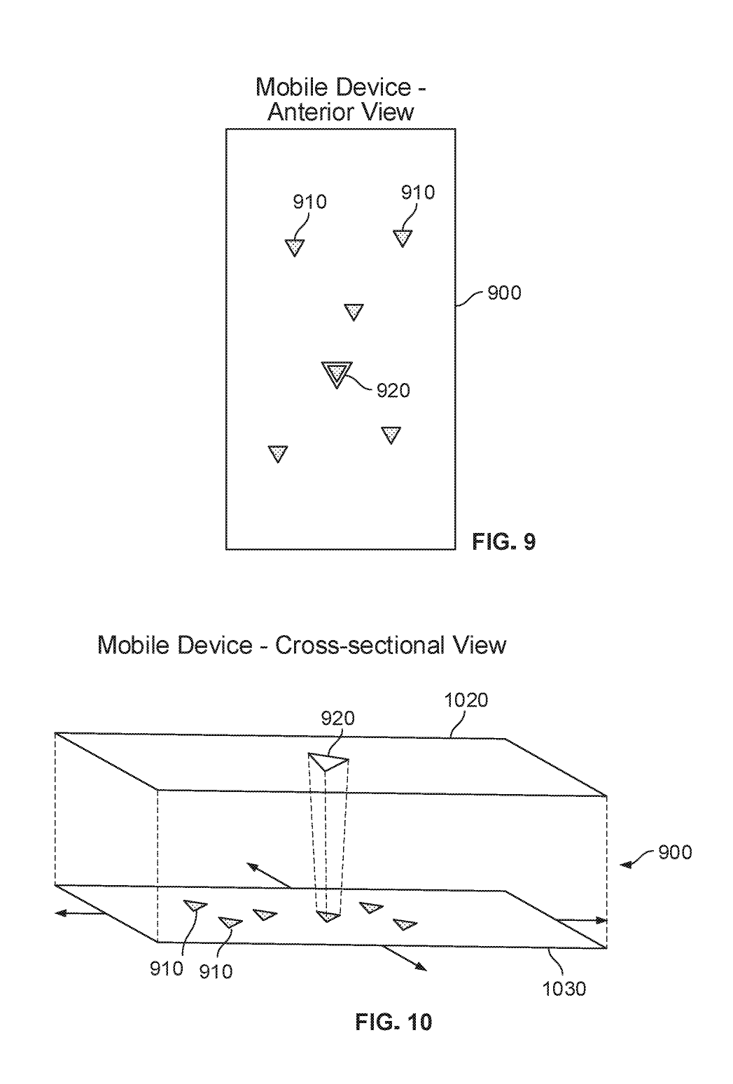

FIG. 9 shows a block diagram of an anterior view of a mobile hover over feature in a display 900. FIG. 10 shows a block diagram of a cross-sectional view of a mobile hover over feature in display 900. FIGS. 9-10 show hover states in touch-sensitive systems. The system comprise a memory, a database stored in the memory, an interface, and a processor. The database stores computer program instructions. The interface includes a touch-sensitive display 900 and a virtual cursor 920. Virtual cursor 920 is a graphical, user-interface object representing a pointing device that resides in a virtual layer 1020 above an interactive, virtual data layer 1030. The user interacts with the data layer by panning the device screen underneath the cursor virtual layer, in order to interact with data represented by icons 910. The processor is coupled to the memory. The processor may be operable for executing the instructions to perform operations. Such operations may include, but are not limited to, detecting a contact with the touch-sensitive display at a point; moving the data layer continuously on the touch-sensitive display 900 underneath the cursor layer 1020, in accordance with a user movement, wherein the user movement maintains continuous contact with the touch-sensitive display; and triggering, based on the cursor landing on content from the data layer 1030, a hover change state.

In some implementations, moving the data layer 1030 includes physical or virtual movement along any desired path. In some implementations, the moving includes movement along a predefined channel from a first predefined location to a predefined hover region. The operations may further include displaying visual cues to communicate a direction of movement. For example, the visual cues may comprise text, an arrow indicating a general direction of movement, or any other suitable visual cue.

Methods for triggering hover states to touch-sensitive mobile devices may comprise detecting a contact with a touch-sensitive display at an undetermined point. A cursor on the touch-sensitive display in a virtual layer atop a data layer, which is continuously moved in accordance with user movement maintaining continuous contact with the touch-sensitive display. The cursor is a graphical, user-interface object with which may land on content in the data layer triggering a hover change state activating the content. In some implementations, the moving includes movement along any desired path. In some implementations, the moving includes movement along a predefined channel from the first predefined location to the predefined hover region. The method may further comprise displaying visual cues to communicate a direction of movement. The visual cues may comprise text, an arrow indicating a general direction of movement, or any other suitable visual cue.

In some implementations, the hover-over is over a batch or series of clustered points. In some implementations, the hover-over is accessed by means of pinch to zoom. In some implementations, the hover-over is overlaid a map-based interface.

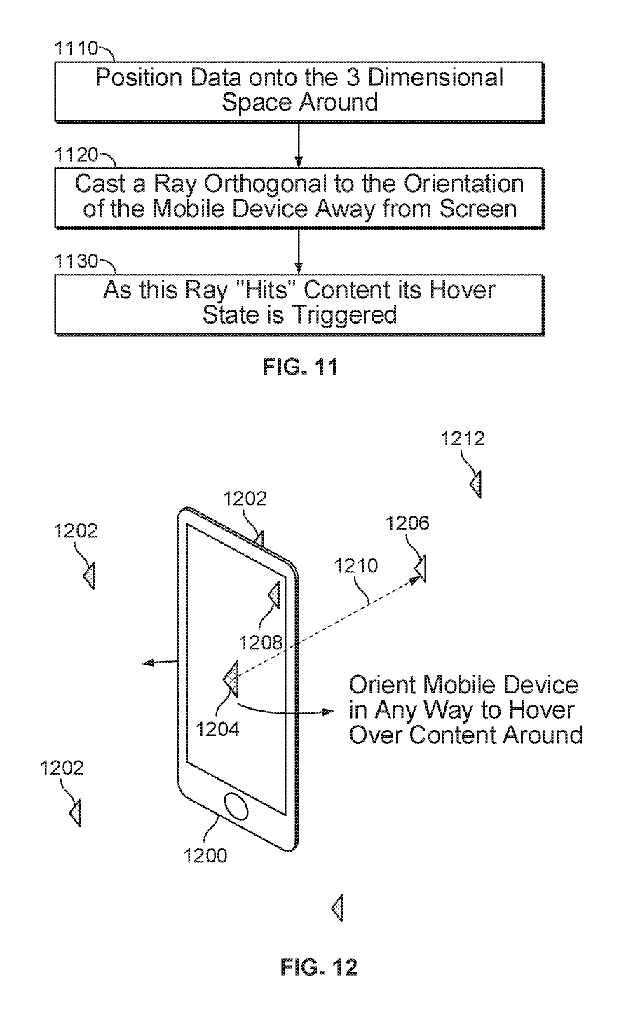

FIG. 11 shows a flowchart of steps of 3D hover over on a mobile device. One problem when users select content in 3D space is that it is difficult to determine which piece of content is being focused on or is interactive. The systems and methods described herein allow a user to point their device's camera at any orientation and receive visual, auditory, and/or haptic feedback by the content they are focusing on. This multi-sensory feedback provides fine-grain control to the user and aides them in the process of exploration. At step 1110, data is positioned onto 3D space around a mobile device (e.g., mobile device 1200 described below). At step 1120, a ray (e.g., ray 1210 described below) is cast orthogonal to the orientation of the mobile device and away from the screen of the mobile device. At step 1130, as the ray ‘hits” content (e.g., content icon 1206, described below), a hover state is triggered.

FIG. 12 shows a diagram of 3D hover over on a mobile device 1200. A user may point a physical device camera (e.g., a camera of mobile device 1200) at any orientation in three-dimensions, casting a virtual ray 1210 at said orientation. Digital content represented by icons 1202, 1206, 1212 positioned in 3D space reacts with hover-over state when hit by this ray. The icons are shown to a user via a screen of their mobile device. Icon 1206 and icon 1212 are shown on the mobile device 900 screen as elements 1204 and 1208, respectively.

The systems and methods described herein cast ray 1210 in any orientation in a 3D space, noting contact with a physical or digital object (e.g., icons 1202, 1206, 1212) and whereby the objects react with a hover over, a screen change or audio indicator. For example, triggering a hover over state caused by a ray-cast unprojected from the mobile device into an established virtual 3D space. The 3D hover over state is triggered when the cast of ray 900 results with a successful hit-test result (i.e., when ray 900 encounters a virtual icon or object), causing the resulting content to indicate the state change or to trigger a cascading action.

The system includes a memory, a database stored in the memory, an interface, and a processor. The database stores computer program instructions. The interface includes a touch-sensitive display (e.g., the touch screen of mobile device 1200) which a user views said digital content on and interacts with. The processor is coupled to the memory. The processor may be operable for executing the instructions to perform operations. Such operations may include, but are not limited to, making digital objects react to ray-cast contact, having the screen itself react, or having audio indicators

In some implementations, the mobile device may display what the camera sees in order to display ray-cast based interactions. In some implementations, the mobile device will not display what the camera sees, and still display ray-cast-based interactions. In some implementations, the mobile device will use haptics to indicate the success or failure of the ray-cast based interaction. In some implementations, multiple device's ray-cast based success needs to be confirmed before an interaction is triggered.

The method of ray-casting in a 3D space may comprise detecting one or more contacts with physical or digital objects (e.g., icons 1202, 1212, 1206). Creating a ray is not limited to visual cues, audio cues, and haptic cues. Ray projection 1210 is used to hit-test against digital content (e.g., icons 1202, 1212, 1206) in the virtual and physical space. Once the device can no longer detect point(s) of content, ray-cast based interaction may cease to be displayed, heard and felt.

In some implementations, the ray-cast projection includes movement along any desired path. In some implementations, the ray-cast projection includes movement along a predefined channel from the first predefined location to the predefined hover region. The method may further comprise displaying visual cues to communicate a direction of movement. The visual cues may comprise text, an arrow indicating a general direction of movement, or any other suitable visual cue.

In some implementations, the casted ray is invisible. In some implementations, the casted ray is hit-tested for digital content in real-time. In some implementations, each hit-test for digital content returns a hit-result or none. In some implementations, a hit-result identifies a unique piece of digital content. In some implementations, a hit-result causes the digital content it identifies to respond with dynamic behavior. In some implementations, the casted ray is hit-tested for physical content in real-time. In some implementations, each hit-test for physical content returns a hit-result or none. In some implementations, a hit-result identifies a unique piece of physical content. In some implementations, a hit-result causes a digital augmentation to the physical it identifies to respond with dynamic behavior. In some implementations, a hit-result causes audio, visual and haptic feedback.

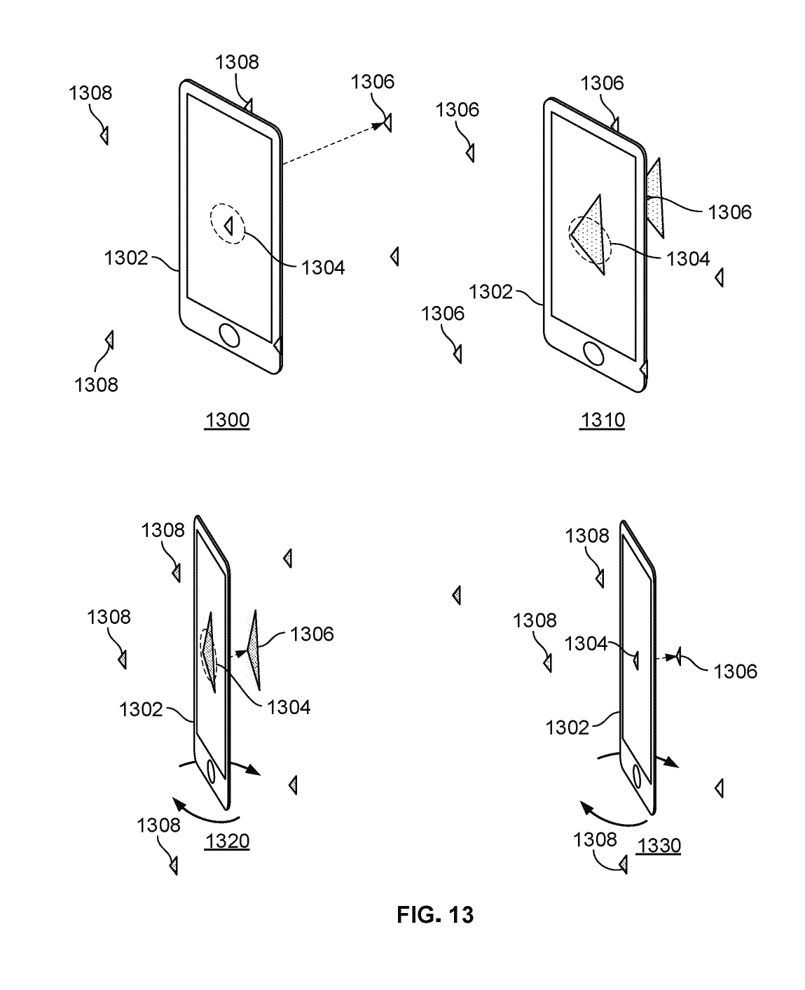

FIG. 13 shows a diagram of the steps of dragging and dropping virtual content in 3D. One problem moving content in virtual 3D space is there is no clear state that indicates when content has been activated for re-positioning. This causes confusion to a user as unwanted effects occur when content is simply tapped on via a touch sensitive display. The systems and methods described herein allow a user to touch and hold digital content on the screen, effectively changing its state into “draggable” allowing repositioning it to a new location within this virtual space. When the user ends such a touch and hold, the content returns to its “dropped” state and its position is set. Such an organic repositioning technique mimics the real-world interaction we have with physical objects that people move. Thus, repositioning content allows a user to manage content in their local space more organically.

Systems and methods described herein allow a user to for select, move and place digital content in a virtual 3D space viewed using a touch-sensitive mobile device. Mobile device 1302 includes a memory, a database stored in the memory, an interface, and a processor. The database stores computer program instructions. The interface of mobile device 1302 includes a touch-sensitive display, which a user views said digital content on, and interacts with. The processor is coupled to the memory. The processor may be operable for executing the instructions to perform operations. Such operations may include, but are not limited to, establishing a 3D virtual space with an origin point in this (“frame of reference”), tracking the movement of the mobile-device and representing said movement in this space by a virtual point-of-view; moving the mobile-device continuously, in accordance with user movement, wherein the user movement triggers movement of the virtual point-of-view, thus displaying digital content placed in the virtual space on the screen of the mobile-device.

At step 1300, a user selects icon 1304 shown on mobile device 1302. Icon 1304 is a representation of object 1306, which is located in the virtual 3D space around mobile device 1302. At step 1310, icon 1304 is enlarged, showing icon 1304 and object 1306 have become “draggable”. At step 1320, icon 1304 is dragged (e.g., by a user pressing and holding on a touch screen and moving his or her finger across the touch screen), repositioning object 1306 as shown. At step 1330, a user “releases” icon 1304 (e.g., lifts his or her finger away from the touch screen), allowing icon 1304 to return to its original size and “dropping” object 1306 at its new user-chosen place in 3D virtual space.

The method of drag-and-drop in a virtual 3D space may comprise detecting one or more contacts with a touch-sensitive display at an undetermined point and creating an unprojection from the point of contact on the screen, where the point of contact is the mean of the points of contact if more than one. The unprojection is used to hit-test against digital content in the virtual space. If the hit-test succeeds, the unprojection vector (of configurable magnitude) anchors (drag step) the hit-test result (digital content) to the said vector if the point(s) of contact is maintained. The movement of the device by the user triggers the movement of the content in the virtual space. Once the device can no longer detect point(s) of content, the content is placed at the last unprojection vector in the virtual space (drop step).

In some implementations, a ray is casted in the orientation of the user's physical device camera. In some implementations, the casted ray is of set length. In some implementations, this ray performs a hit test and a successful hit-result is a piece of digital content. In some implementations, the digital content is moved to the vector point at the trailing end of the cast ray as the user applies the drag-and-drop function. In some implementations, the digital content is placed to the vector point at the trailing end of the cast ray when the user ends the drag-and-drop function. In some implementations, the content is long-pressed long-pressed and moved. In some implementations, the content is tapped and moved. In some implementations, the content is hard pressed and moved. In some implementations, the content is flicked to move. In some implementations, the content is swiped to move. In some implementations, the content is spun to rotate in locked position.

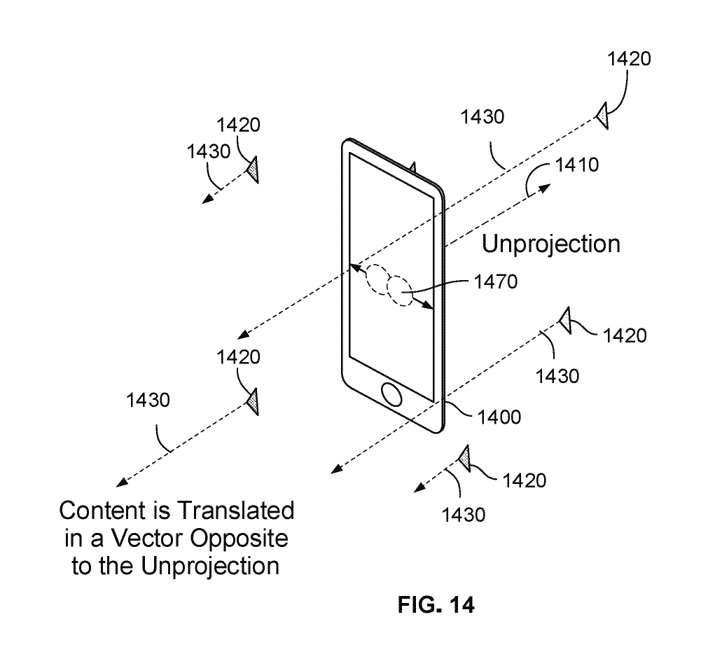

FIG. 14 shows a diagram of pinch-gesture based movement on a mobile device. One problem in exploring digital content mapped over a real-world 3D space is that users have to physically move to the geo-mapping of this content. The systems and methods described herein allow a user to use a pinch-gesture on a touch-sensitive display to move content closer or further to them, as if they had physically moved closer to the content itself, thus allowing a user to utilize a pinch-gesture to move through virtual content placed in his or her local, 3D physical space.

The systems and methods described herein allow for movement within a virtual space using a touch-gesture. A user may “pinch” on a screen of a mobile device 1400, causing digital content represented by icons 1420 placed within this space to be translated opposite to the direction a camera of the mobile device 1400 is facing. Vectors 1430 represent a direction opposite to the direction the camera of mobile device 1400 is facing. Vector 1410 represents an unprojection. Pinch-gesture 1470 shows how a user placed two fingers in the middle of the screen of mobile device 1400 and moved those two fingers away from one another towards opposite ends of the screen.

The mobile device includes a memory, a database stored in the memory, an interface, and a processor. The database stores computer program instructions. The interface includes a touch-sensitive display, which a user views said digital content represented by icons 1420 on and interacts with. The processor is coupled to the memory. The processor may be operable for executing the instructions to perform operations. Such operations may include, but are not limited to, detecting contact with the touch-sensitive display at one or more points; designating the mean of given points if more than one as the trigger point, unproject a vector using the trigger point in the direction of the back camera, mapping the velocity of the gesture to a velocity of translation of content positions in the virtual space and rendering the content along the unprojection vector based on the gesture.

In some implementations, a two-finger pinch-gesture 1470 may be used. The point in the middle of the two detected touch points is designated the trigger point and the velocity and sub classification (pinch-inward/pinch-outward) of the gesture may be used to translate the positioning of the digital content. In some implementations, a visible or invisible slider may be used to move content back and forth along the unprojected vector. Given slider may be placed horizontally or vertically on the display screen. When content moves behind the virtual point-of-view (representation of the physical device) in real world space, the content is no longer visible on the display. The movement of the digital content as a result of the triggering gesture may render an animation state such as motion blurs or others between the start and end positions of the content.

In some implementations, an unprojection from the display is made into the orientation of virtual camera in a virtual space containing digital content. In some implementations, the unprojection vector defines the orientation of movement and the velocity of movement is defined as a function of the gesture. In some implementations, digital content is translated within the virtual environment using the negated vector, thereby allowing user to effectively “visit” each piece of content. In some implementations, the entire digital realm zooms in. In some implementations, the entire digital realm zooms out. In some implementations, one piece of content zooms in. In some implementations, one piece of content zooms out. In some implementations, multiple selected piece of content zoom in. In some implementations, multiple selected piece of content zoom out.

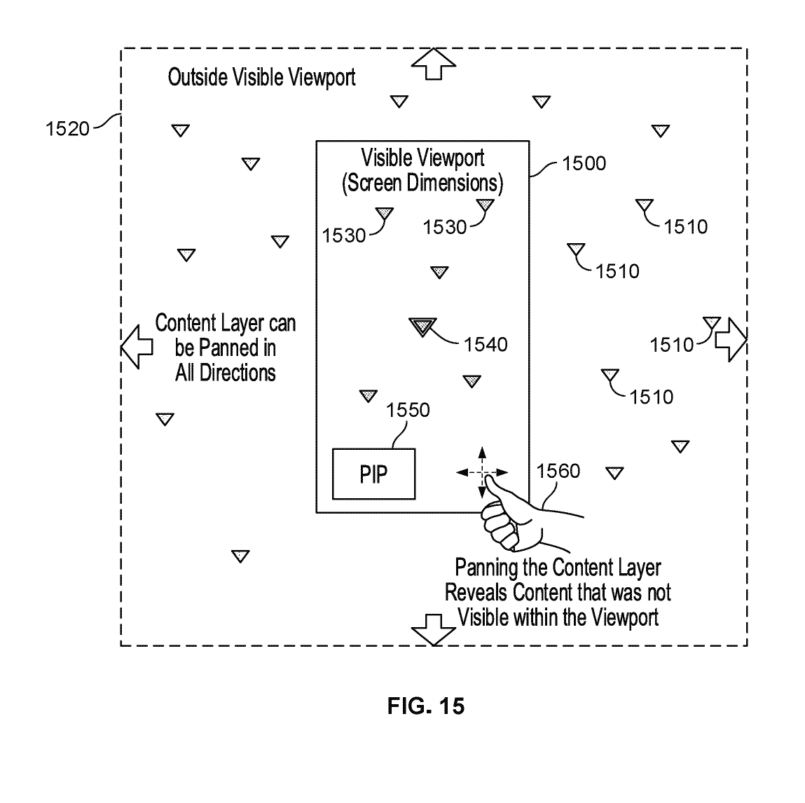

FIG. 15 shows a block diagram of non-linear geography based content discovery. One problem associated with using touch screens on portable devices is the linear methodology used to discover content. The concept of “the feed” gained traction with RSS technologies and has become the de facto method of content delivery on never every major social network. By implementing a network with a non-linear method of content discovery, new content interactions and interfaces are possible. For example, a device with a touch-sensitive display may be navigated using a cursor-based interface layered on top of a map-based interface. The cursor moves as a user swipes the display with his or her finger. The cursor can move in 360 degrees and thus access content in a linear way.

The systems and methods described herein allow geographical discovery of digital content in a non-linear fashion. The system shown in FIG. 15 shows data on a virtual layer like a map, with visible and non-visible regions represented by the device screen 1500, a mobile hover over cursor 1540 for content selection and a peer-in-preview 1550 for content display. The system includes a memory, a database stored in the memory, an interface, and a processor. The database stores computer program instructions. The interface includes a touch-sensitive display which a user views said digital content on and interacts with. The processor is coupled to the memory. The processor may be operable for executing the instructions to perform operations. Such operations may include, but are not limited to, overlaying geo-located data on a map interface (data layer), calculating content closest to the cursor in screen space, updating the peer-in-preview display with the media from selected content, hiding and revealing content that is on or off the screen in all directions on the display screen plane.

In some implementations, data represented by icons 1510 overlaid on the map interface may not be located at displayed coordinates. Relevance algorithms or other naive approaches may be used to superficially place such data on the map interface 1520. In some implementations, the panning (e.g., by user 1560) of the data layer (map interface 1520) fetches data over the network and displays it as user-visible icons 1530 on display 1500 as the panning is active. The region of map interface 1520 displayed on the screen 1500 determines, which data is to be retrieved from the server. For example, icons 1510 represent data that is not retrieved from the server, because icons 1510 are not within the “view” of display 1500. In some implementations, the starting or the stopping of the panning action triggers fetching new data from the server. For example, the mobile device may fetch new data as the device is panned or fetch data once the panning has stopped. Content loaded into the map may be unique and subsequent fetches containing the same data may not update visual attributes of existing overlaid data.

In some implementations, the moving includes movement along any desired path. In some implementations, the moving includes movement along a predefined channel from the first predefined location to the predefined content region. In some implementations, visual cues are displayed to communicate a direction of movement. In some implementations, the visual cues comprise text. In some implementations, said visual cues comprise an arrow indicating a general direction of movement. In some implementations, the user interacts with the device through the real movement of a physical body. In some implementations, a user can zoom in for content discovery. In some implementations, a user can zoom out for content discovery. In some implementations, content is clustered together and algorithmically presented the most relevant content. In some implementations, content is clustered together and presented highest ranked user content first.

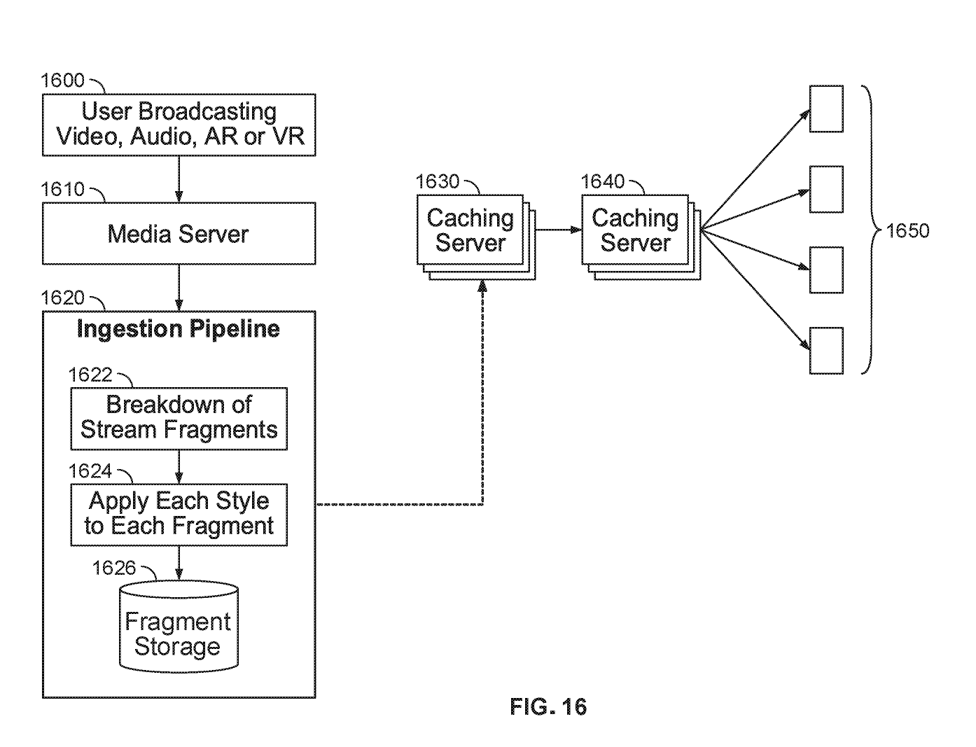

FIG. 16 shows a schematic diagram of live transmission of video, audio, augmented reality, and virtual reality with style transfer. One of the challenges of applying style transfer in live transmissions is the time it takes to compute alterations for data of large sizes. The systems and methods described herein break down a monolithic piece of data into smaller chunks and apply neural network based algorithms en route to a client or media player. An effect of this technique is that the final output does not have to be fully computed before being delivered giving the user the ability to change the style or mood of the output on-demand. HTTP Live Streaming video, audio, augmented reality and virtual reality data with style transfer applied to chunks or segments of data en route to a client or media player allowing consumer to select style to apply to the stream of data.

The systems and methods described herein allow the concept of style transfer to be applied to live transmission of media. For example, the system of FIG. 16 breaks down the transmission of media types like audio streams, video streams, or any other suitable steam into small chunks of data, applying a style-model selected by the user using a mobile device to each of these chunks en route from a media server, to a RTMP server, finally into a caching cluster making the chunks available at scale to the users. The system includes a memory, a database stored in the memory, an interface, and a processor. The database stores computer program instructions. The interface includes a touch-sensitive display, which a user views said digital content on, and interacts with. The processor is coupled to the memory. The processor may be operable for executing the instructions to perform operations. Such operations may include, but are not limited to, broadcasting a live stream of data over the network to a media server, selecting a style model (represented by a filter on the device screen) and receiving a stream of data chunks of the same media type with the selection model applied to them.

At step 1600, a user broadcasts a video steam, audio stream, augmented reality (AR) or virtual reality (VR). At step 1610, the broadcasted stream is sent to media server. The stream then enters an ingestion pipeline 1620. The ingestion pipeline includes three steps. At step 1622, stream fragments are broken down into smaller segments or fragments. At step 1624, each style is applied to each fragment. At step 1626, the fragments are saved in fragment storage. The “styled” fragments from step 1626 may be replicated to geographically distributed servers called caching servers. As shown in FIG. 16, from ingestion pipeline 1620, the fragments are sent to caching server 1630. From caching server 1630, the fragments are sent to caching server 1640 where the stream is distributed to devices 1650. Caching servers 1630, 1640 respond to queries by clients (e.g., desktop browsers, mobile apps, or any suitable user device and/or interface). The servers 1630, 1640 may have the ability to determine which fragments to communicate with based on various factors like client geolocation, preferences, configuration, or any suitable factor. For example, a user viewing a live video stream on a browser video-player may be able to apply a “Van Gogh” style to the video stream if the Van Gogh style is available at their location and they choose to apply it.

In some implementations, the mobile device may apply the style model on-device before relaying it to the media server. Here, the style model applied has to be available on the device prior to the transmission of the data stream. Application of the style transfer may suspend, without suspending the transmission itself, if the mobile device is resource constrained. In some implementations, the mobile device may transmit the data stream over the network to a media server for segmentation into chunks. In such scenarios, the style model selection will be applied to the chunks in an offline ingestion pipeline that performs the application. In some implementations, data stream chunks outputted by the media server pipeline may be passed down to the RTMP server with a switch determining whether to cache given chunks. When the switch is true, the chunks are cached in the caching cluster. Otherwise, they are transmitted directly to any connected mobile device.

In some implementations, a neural network model is applied to transfer a style or a mood to a chunked or segmented stream of data. In some implementations, the neural network model produced by training a neural network on a predefined set of claimed data types. In some implementations, the style comprises the artistic elements of a video, audio, VR or AR subject. In some implementations, the mood includes the sentimental elements of a video, audio, VR or AR subject. In some implementations, the style intrinsically alters the target video, audio, VR or AR chunk or segment. In some implementations, the mood intrinsically alters the target video, audio, VR or AR chunk or segment. In some implementations, the chunks or segments of data are style transferred prior to the client end receiving them. In some implementations, the content is streamed in a one to many manner. In some implementations, the content is streamed in a one to one manner. In some implementations, the content is automatically fed to multiple distribution channels. In some implementations, the content is automatically fed to multiple distribution channels in a uniquely segmented manner. In some implementations, the content is automatically saved as it is processed.

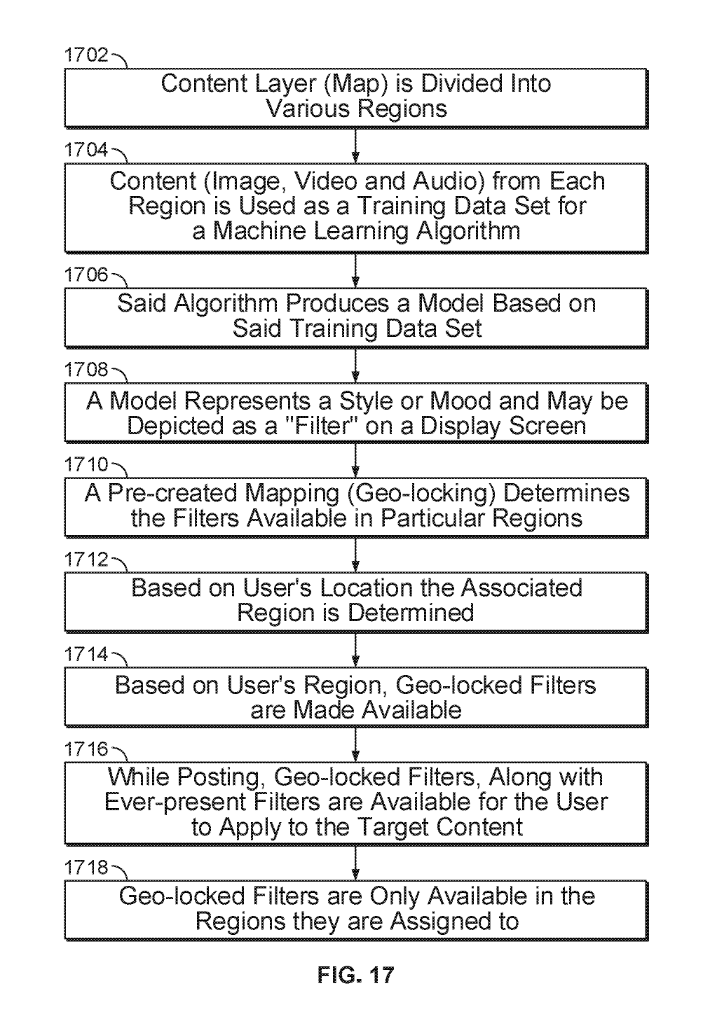

FIG. 17 shows a flowchart of geo-locked style transferring of image, video, and audio. One problem associated with using touch screens on portable devices is the similarity in how content is displayed from region to region. The concept of physical proximity triggering machine learning based alteration to content is one that will bring forward a more evergreen approach to content generation and curation. Various techniques relating to the “style transfer” alteration of image, audio and video are provided herein. In general, disclosed embodiments may provide techniques for applying on image, audio and video one or more “style transfer” alteration effects on a mobile device. In the disclosed embodiments, the application of such image, audio and video “style transfer” alteration effects are triggered by location related events.

At step 1702, a content layer or map is divided into various regions. At step 1704, content from each region is used as a training data set for a machine-learning algorithm. Content may include, for example, image, video, audio, or any other suitable content. Machine learning algorithms include, for example, linear regression, logistic regression, classification and regression trees, Bayesian modeling, nearest neighbor modeling, bagging and random forest, gradient boosting algorithms, or any other suitable algorithm. At step 1706, the machine-learning algorithm produces a model based on the training data set. At step 1708, the model represents a style or mood and may be depicted as a “filter” on a display screen. For example, the filter may alter the coloring or saturation of a user's touch screen display. At step 1710, a pre-created mapping determines the filters available in particular regions. In some examples, the pre-created mapping is geo-locked in a specific physical area. At step 1712, the system determined the region associated with a user's location. At step 1714, based on the user's region, geo-locked filters are made available to the user. At step 1716, geo-locked filters and ever-present filters are made available to the user when the user is posting. The filters may be applied to target content. At step 1718, geo-locked filters are only available in the regions they are assigned to. In some implementations, step 1718 is optional and geo-locked filters may be accessed through other means than location.

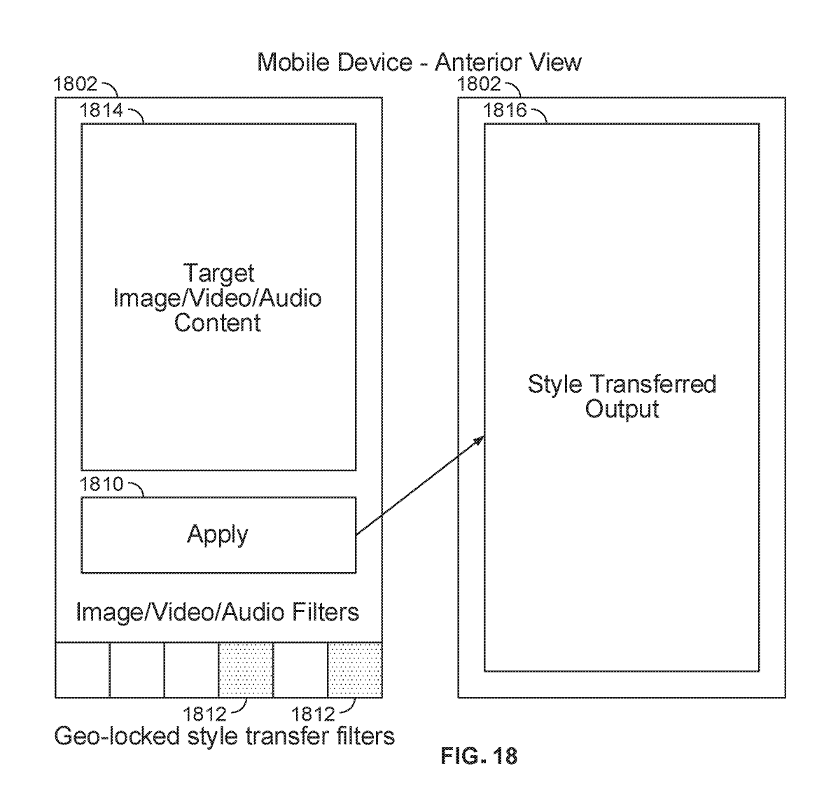

FIG. 18 shows a block diagram of a mobile device with geo-locked style transferring. The device depicted in FIG. 18 may implement, alone or in conjunction with other systems, the steps of FIG. 17 described above. The device includes an interface 1802. Interface 1802 includes a touch-sensitive display, which a user views said digital content on and interacts with. Interface 1802 displays target image, video, and/or audio content in display box 1814. A user can select image, video, and/or audio filters, including geo-locked style transfer filters 1812. Once a user has selected filter, the user may apply those filters to the target content by pressing apply 1810 on the interface. Pressing apply 1810 on the interface 1802 causes the target content previously displayed in display 1814 to be filtered using the selected filter, and then displayed with the transferred style, at style transferred output display 1816.

The device may further comprise a memory, a database stored in the memory, and a processor. The database stores computer program instructions. The processor is coupled to the memory. The processor may be operable for executing the instructions to perform operations. Such operations may include, but are not limited to, using neural networking techniques to generate style models using geo-located data, applying the generated models to selected content of the same media type and outputting content as a result.

In some implementations, real-world coordinates will be pre-divided to form data sectors. Content from the data sector would be used to generate a style model of the given sector. Style models, represented as filters, would be made available for the user to select for application on demand onto further content. In some implementations, user location would be used to shortlist content for style-model generation. In some implementations, style models would be generated asynchronously on the server and applied to any content is geo-located within a predefined data sector. In such implementations, a map interface may have its tiles representing a data sector be style transferred with the associated style model.

In some implementations, the application of such image, audio and video “style transfer” alteration effects are triggered by location-related or user movement-related events. In some implementations, the location-related event includes physical movement along any desired path form the first predefined location to the predefined unlock region. In some implementations, the location-related event includes physical movement along any desired path form the first undefined location to the predefined unlock region. In some implementations, visual cues (e.g., text, arrows, images, etc.) are displayed to communicate a direction of movement. In some implementations, the location-related event includes digital movement along any desired path form the first undefined location to the predefined unlock region. In some implementations, unique style transfers are triggered or assigned to different countries, states, cities neighborhoods, or the vicinity of specific users.

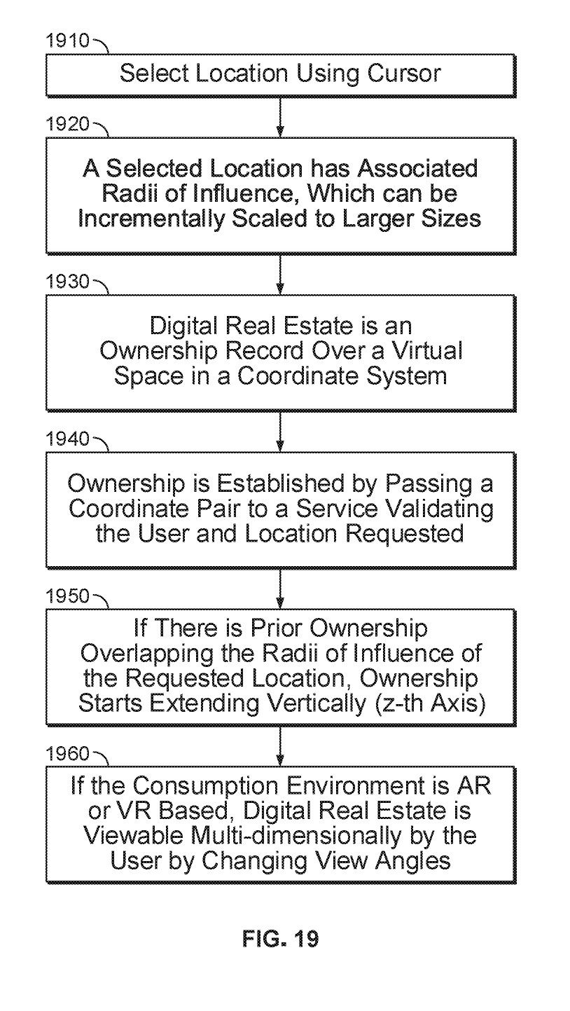

FIG. 19 shows a flowchart of steps for binding digital real estate to physical coordinates. One problem with digital games in which real estate is bought and sold is that in no way ties into the real world. The systems and methods described herein tie in digital real estate to physical coordinates as an overlay to the real world, thereby creating a mixed reality. The mechanism for ownership or tenancy of virtual space mapped onto a physical coordinate system such as a map interface, as well as the virtual “air rights” to that space. Tenancy in given virtual space is finite and expires after a set period of time.

At step 1910, a location is selected via a cursor. For example, a user may position a cursor over a location on a display and click that location to select it. At step 1920, the selected location is associated with radii of influences. The radii of influences can be incrementally scaled to larger sizes. In some implementations, the selected location has already been associated with the radii of influences and step 1920 is optional. At step 1930, digital real estate is recorded as an ownership record over space in a coordinate system. In some implementations, a preexisting ownership record is in force, and step 1930 is optional. At step 1940, ownership is established by passing a coordinate pair to a service that validates the user and location requested. At step 1950, if there is prior ownership overlapping the radii of influence of the requested location, ownership starts extending vertically (e.g., in the z-th axis). At step 1960, if the consumption environment is AR- or VR-based, digital real estate is viewable multi-dimensionally by the user by changing view angles.

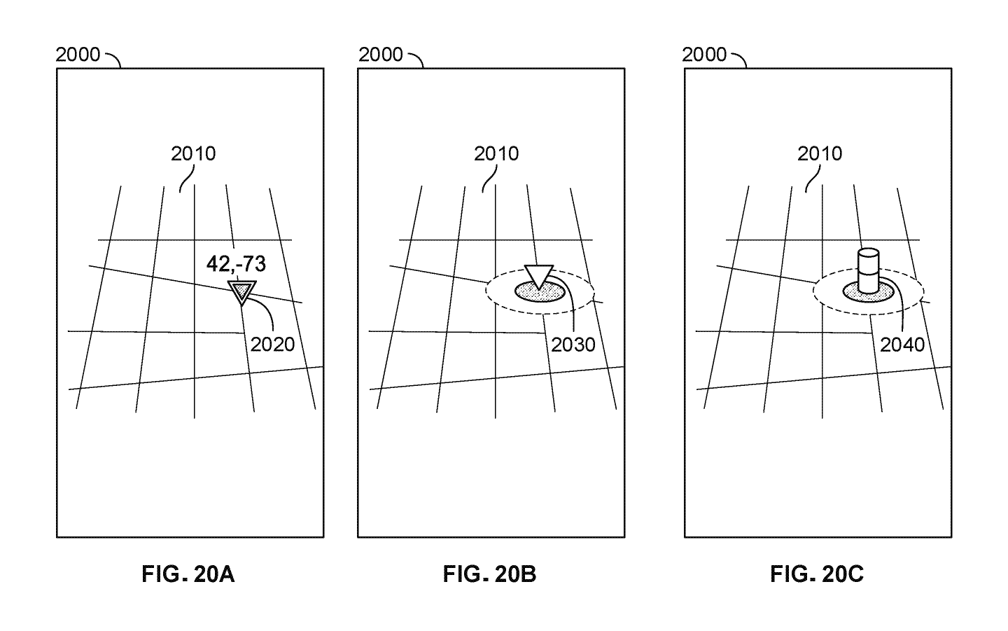

FIG. 20A-C show a block diagram of digital real estate bound to physical coordinates, as described in relation to FIG. 19 above. FIG. 20A-C show a display 2000 of a mobile device. In FIG. 20A, a user selects, via cursor 2020, a point at coordinates 42-73 on map 2010. In FIG. 20B, icon 2030 represents the ownership of the location at coordinate 42-73. In FIG. 20C, because the location at coordinate 42-73 was previously owned, the new ownership is “stacked” on old ownership, to create icon 2040, which represents dual ownership of the marked location. In some implementations, digital stores are mapped to physical addresses, so entities can buy and claim land corresponding to physical locations. Such systems may lead to a marketplace where users complete financial transactions on this land, and an owner of the system and/or location gets a financial stake in the transaction. Binding digital real estate to physical coordinates allows users or clients to digitally sell goods and services at fixed physical locations. For example, businesses may rent or buy specific plots of digital land that “live” on top of current physical stores. The digital land may be owned by the same entity as the owner of the physical store, or a different owner. For example, Company A may own physical property and have a store at Location A. Company B may buy a digital plot of land at Location A. A user pointing his or her mobile device at Company A's store at Location A may see, through the mobile device's user interface, a digital storefront for Company B. Thus, the user may digitally shop at Company B, while physically located at a store of Company A. One benefit of such a system is allowing a user to digitally buy the same products sold by Company A via Company B. For example, the products may be sold at a discounted rate or user may be otherwise incentivized to but the product via the digital storefront of Company B rather than from the physical store of Company A.

In some implementations, ownership or tenancy is designated from a map-based interface that can be panned around in 2D space or from a 3D virtual space corresponding to real world coordinate space. In some implementations, tenancy exists for a finite period of time. Once tenancy expires, the owner is free to lease the virtual space to another tenant. In some implantations, air space is described as the 3D extrusion of the virtual space on the real world coordinate system along the vector opposite the gravity vector. In some implementations, the ownership or tenancy of virtual space includes ownership or tenancy of its corresponding air space. In some implementations, a contract is provided by the overarching system to an owner or from an owner to another owner or tenant specifying the terms of ownership or tenancy.

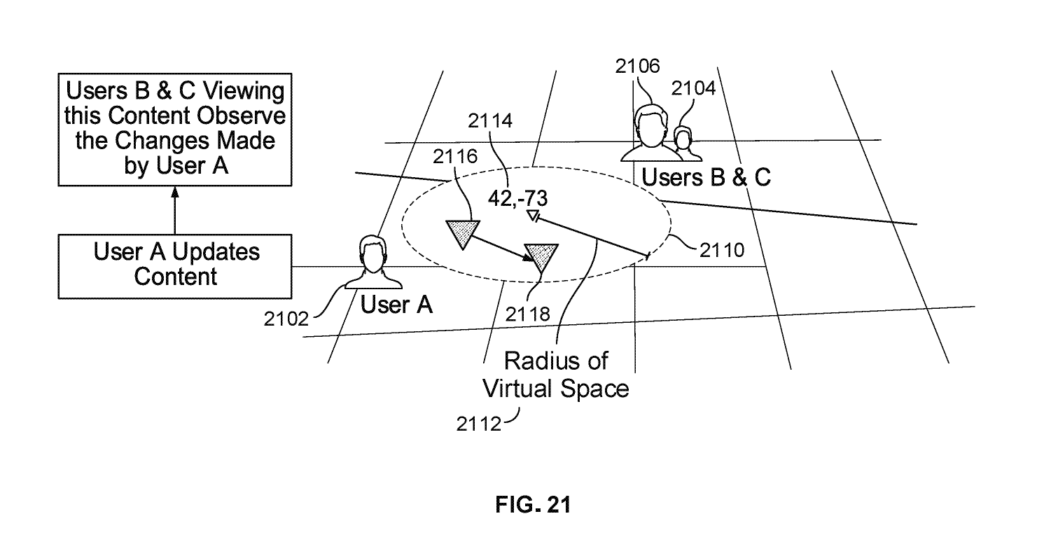

FIG. 21 shows a block diagram of real-time person-to-person interaction in a virtual space 21. One problem a 3D virtual world is the lack of social and dynamic interaction. The systems and methods described herein allow users to interact with digital content in real time, applying dynamic effects like drag-and-drop, doodle, or any other suitable effect, along with the ability to interact with each other via virtual representations. A user can interact with other users and dynamic digital content within a virtual space, providing a real-time stream of events that allow multiple users to interact with digital content and embodiments of each other. In some implementations, these activities are tied to a physical space.

FIG. 21 represents a radius 2112 of virtual space for a set of users, User A 2102, User B 2104, and User C 2106. The radius 2112 extends from a coordinate 2114 at 42-73. When User A changes content within the radius 2112 of virtual space, User B 2104 and User C 2106 may observe these changes in real time. As shown in FIG. 21, User A 2102 moves a content icon from a first location 2116 to second location 2118. User B 2104 and User C 2106 may then view the content at location 2118, rather than at location 2116. In some implementations, users may observe these changes in real time. In some implementations, there is a slight lag between when a first user makes a change and other viewers can see this change. For example, a remote server may need to refresh before the change is visible to other users.

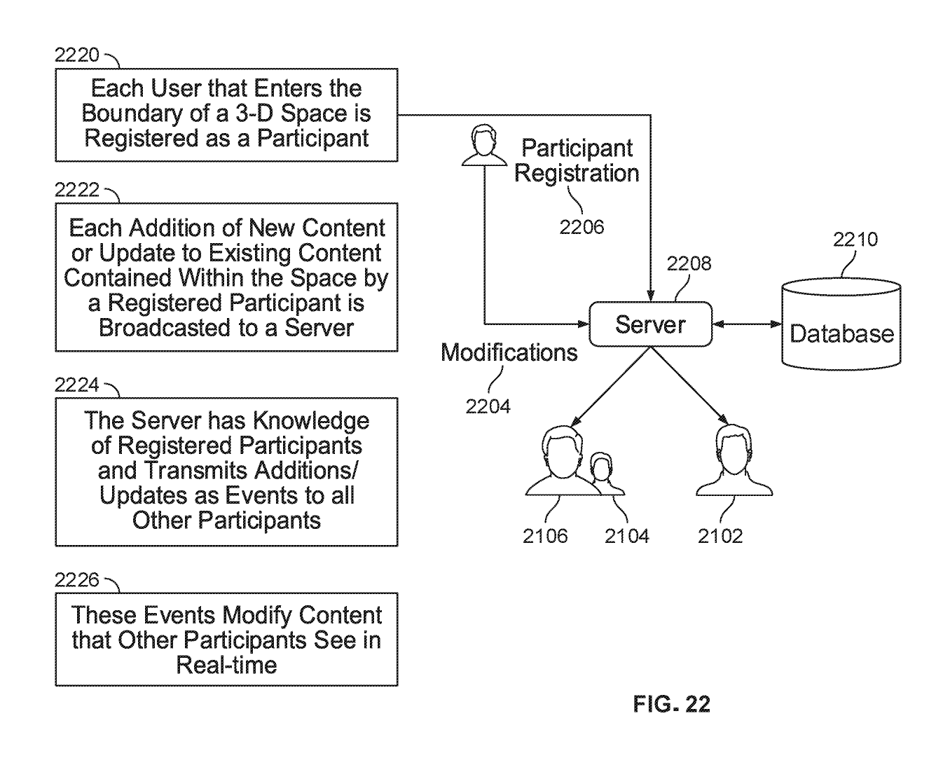

FIG. 22 shows a flowchart of steps for real-time person-to-person interaction in a virtual space. The systems and methods described herein provide solutions to map physical space to digital content that can be interacted with in a real time, providing a peer-to-peer independent view, as described above in relation to FIG. 21. This content can be either actual people, images, videos, live streams, free hand doodles or audio objects. The system includes a memory, a database stored in the memory, an interface, and a processor. The database stores computer program instructions. The interface includes a touch-sensitive display, which a user views said digital content on, and interacts with. The processor is coupled to the memory. The processor may be operable for executing the instructions to perform operations. Such operations may include, but are not limited to, broadcasting of content, location and real time interaction with content and receiving a stream of data chunks of the same content type with the real time actions recorded.

At step 2220, each user that enters the boundary of a 3D space is registered as a participant of that space. At step 222, each addition of new content or update to existing content contained within the space by a registered participant is broadcast to a server. At step 2224, the server 2208 has knowledge of registered participants (e.g., users 2102, 2104, 2016 registered at participant registration 2206) and transmits additions and updates (e.g., modifications 2204) to the content with the space as events to all other registered participants. Such information is stored in database 2210, which the server communicates with. At step 2226, these events modify content that other participants see in real time.

In some implementations, the placement of content is recorded. In some implementations, interaction with content is recorded. In some implementations, live streaming video that is recorded. In some implementations, the location of content being moved to different physical locations is recorded. In some implementations, the location of content being moved to different digital locations is recorded. In some implementations, the creation of content is recorded. In some implementations, edit of content is recorded.

In some implementations, digital content in a virtual world is accessible to multiple users in real-time, and multiple users can interact with said content in real-time. In some implementations, each user in the virtual space is embodied by some virtual representation. In some implementations, users can interact with the virtual embodiments of other users.

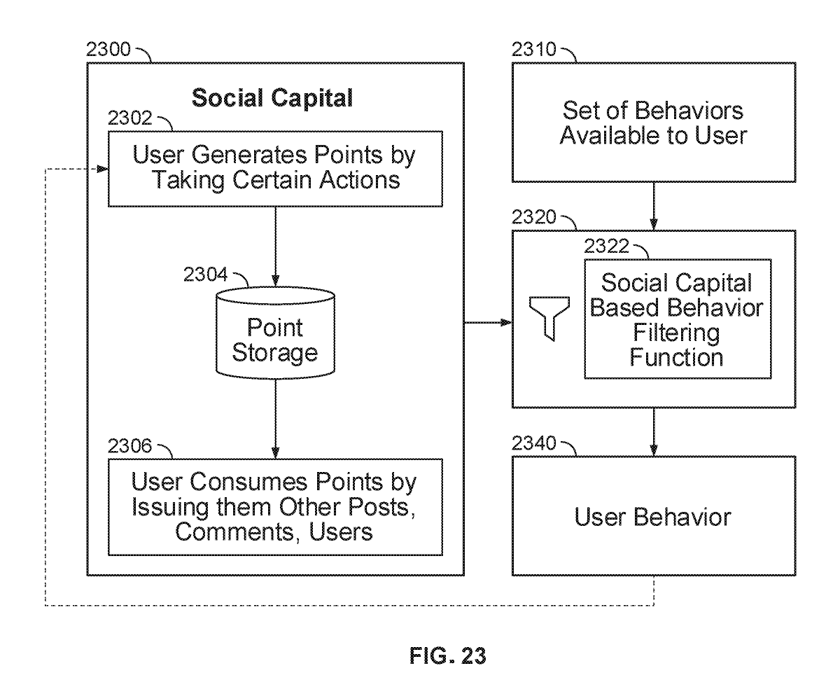

FIG. 23 shows a schematic diagram of a digital social capital point system 2300. One of the main problems on current social media is that all content is ranked one-for-one. One “like” of a post does not scale to the social capital of the liker. In the system and methods described herein, a user accrue points (or likes) or distribute points. For example, instead of giving one like, a user could give five likes. In some implementations, the amount of points a user can give or receive is scaled based on the social capital of that user. For example, a user with more social capital could give 40 points instead of 10. Such implementations allow users to not only show appreciation for a post, but also quantitatively show how much they appreciate a post. This allows users to gauge emotional reaction by allowing certain emotional indicators and show how much they value a post via being able to assign it multiple points. The point system may exist on a scale both online and offline that can be used to rank content. The points can be distributed to content based on the total number of points that a user has, allowing a user to re-distribute points (i.e., the more points a user has the more social capital he or she can give).

The scaled point mechanism described here may be used to attribute value for specific content. For example, a picture of a puppy can be given 1-10 “free” points, and further additional points taken from the user's social capital can highlight said user's appreciation for the content. The system includes a memory, a database stored in the memory, an interface, and a processor. The database stores computer program instructions. The interface includes a touch-sensitive display, which a user views said digital content on, and interacts with. The processor is coupled to the memory. The processor may be operable for executing the instructions to perform operations. Such operations may include, but are not limited to, rating an image, text, sound, illustration, collage or color.

Box 2310 represents a set of behaviors available to a user. For example, such behaviors may include lining a post, disliking a post, posting a picture or text, or any other suitable behavior. Box 2310 interfaces with box 2320, which represents sets of behavior dependent on social capital. Rules governing social capital are shown in box 2300. At step 2302, a user generates points by taking certain actions (e.g., posting a photo, receiving likes, etc.). The generated points are stored in point storage 2304. At step 2306, a user consumes points by taking other actions (e.g., issuing points on other posts, commenting, etc.). The rules governing social capital shown in step 2302 can then be used at box 2322 so provide a social capital-based behavior filtering function, which in turn affects user behavior at box 2340.

In some implementations, a user assigns free points. In some implementations, the user assigns points that are deducted from his or her account's social capital. In some implementations, a user assigns a negative number value to content. In some implementations, a user may purchase points to distribute. In some implementations, a user is given a random daily allotment of points to distribute. In some implementations, a user is given a predetermined daily allotment of points to distribute. In some implementations, point-affecting actions can done both online and offline, or through any other means of wired or unwired connectivity.

This description is merely illustrative of the principles of the disclosure, and the systems and methods can be practiced by other than the described implementations, which are presented for purposes of illustration and not of limitation. It is to be understood that the systems and methods disclosed herein, while shown for use in augmented reality, may be applied to systems to be used in device processes.

Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented.

Examples of changes, substitutions, and alterations are ascertainable by one skilled in the art and could be made without departing from the scope of the information disclosed herein.

### EXEMPLARY ASPECTS

A1. An algorithm for placing digital content with some virtual size.
A2. The method of claim A1, wherein the content's virtual size can be mapped to real-world space.
A3. The method of claim A1, wherein the content is distributed over space mapped in the real-world such that collisions or clustering do not occur.
A4. The system of claim A1, wherein the operations further comprise displaying visual cues to communicate a direction of movement.
A5. The system of claim A4, wherein the visual cues comprise text.
A6. A method placing content manually in a 3D space, by means of mouse and keyboard.
A7. The method of claim A6, wherein, on a touch device, the content is long-pressed and placed.
A8. The method of claim A6, wherein, on a touch device, the content is tapped and placed.
A9. The method of claim A6, wherein, on a touch device, the content is hard pressed and placed.
A10. The method of claim A6, wherein, on a touch device, the content is flicked to placed.
A11. The method of claim A6, wherein, on a touch device, the content is swiped to placed.
A12. The method of claim A6, wherein, on a touch device, the content is spun to rotate in placed position.
B1. A method for re-positioning digital content in virtual three-dimensions mapped over the real-world.
B2. The method of claim B1, wherein a ray is casted in the orientation of the user's physical device camera.
B3. The method of claim B1, wherein the casted ray is of set length.
B4. The method of claim B1, wherein a hit test is performed by this ray and a successful hit-result is a piece of digital content.
B5. The method of claim B1, wherein the digital content is moved to the vector point at the trailing end of the cast ray as the user applies the drag-and-drop function.
B6. The method of claim B1, wherein the digital content is placed to the vector point at the trailing end of the cast ray when the user ends the drag-and-drop function.
B7. The method of claim B1, wherein the content is long-pressed and moved.
B8. The method of claim B1, wherein the content is tapped and moved.
B9. The method of claim B1, wherein the content is hard pressed and moved.
B10. The method of claim B1, wherein the content is flicked to move.
B11. The method of claim B1, wherein the content is swiped to move.
B12. The method of claim B1, wherein the content is spun to rotate in locked position.
C1. A method for introducing the concept of “style transfer” alteration effects on a mobile device, the method comprising: the application of such image, audio and video “style transfer” alteration effects are triggered by location related events.
C2. The method of claim C1, wherein the moving comprises physical movement along any desired path form the first predefined location to the predefined unlock region.
C3. The method of claim C1, wherein the moving comprises physical movement along any desired path form the first undefined location to the predefined unlock region.
C4. The method of claim C1, further comprising displaying visual cues to communicate a direction of movement.
C5. The method of claim C4, wherein the visual cues comprise text.
C6. The method of claim C4, wherein said visual cues comprise an arrow indicating a general direction of movement.
C7. The method of claim C1, wherein the moving comprises digital movement along any desired path form the first predefined location to the predefined unlock region.
C8. The method of claim C1, wherein the moving comprises digital movement along any desired path form the first undefined location to the predefined unlock region.
C9. The method of claim C1, wherein different countries have specific, unique style transfers.
C10. The method of claim C1, wherein different states have specific, unique style transfers.
C11. The method of claim C1, wherein different cities have specific, unique style transfers.
C12. The method of claim C1, wherein different neighborhoods have specific, unique style transfers.
C13. The method of claim C1, wherein being near specific people triggers unique style transfers.
C14. The method of claim C1, wherein being near specific landmarks triggers unique style transfers.
C15. The method of claim C1, wherein being near specific objects triggers unique style transfers.
C16. The method of claim C1, wherein being in a specific altitude triggers unique style transfers.
C17. The method of claim C1, wherein being in a specific date/time triggers unique style transfers.
C18. The method of claim C1, wherein going a certain MPH triggers unique style transfers.
D1. A method for applying a neural network model to transfer a style or a mood to a chunked or segmented stream of data.
D2. The method of claim D1, wherein the neural network model produced by training a neural network on a predefined set of claimed data types.
D3. The method of claim D1, wherein the style comprises the artistic elements of a video, audio, VR or AR subject.
D4. The method of claim D1, wherein the mood comprises the sentimental elements of a video, audio, VR or AR subject.
D5. The method of claim D3, wherein the style intrinsically alters the target video, audio, VR or AR chunk or segment.
D6. The method of claim D4, wherein the mood intrinsically alters the target video, audio, VR or AR chunk or segment.
D7. The method of claim D1, wherein the chunks or segments of data are style transferred prior to the client end receiving them.
D8. The method of claim D1, wherein the content is streamed in a one to many manner. D9. The method of claim D1, wherein the content is streamed in a one to one manner. D10. The method of claim D1, wherein the content is automatically fed to multiple distribution channels.
D11. The method of claim D1, wherein the content is automatically fed to multiple distribution channels in a uniquely segmented manner.
D12. The method of claim D1, wherein the content is automatically saved as processed.
E1. A method for introducing the concept of hover states to touch-sensitive mobile devices, the method comprising: detecting a contact with the touch-sensitive display at a undetermined point; continuously moving the cursor on the touch-sensitive display in accordance with movement based on continuous contact with the touch screen is maintained, wherein the cursor is a graphical, interactive user-interface object with which a user interacts in order to navigate the device; and triggering a hover change state activing content if cursor lands on the content.
E2. The method of claim E1, wherein the moving comprises movement along any desired path.
E3. The method of claim E1, wherein the moving comprises movement along a predefined channel from the first predefined location to the predefined hover region.
E4. The method of claim E1, further comprising displaying visual cues to communicate a direction of movement.
E5. The method of claim E4, wherein the visual cues comprise text.
E6. The method of claim E4, wherein said visual cues comprise an arrow indicating a general direction of movement.
E7. The method of claim E1, wherein the hover-over is over a batch of clustered points
E8. The method of claim E1, wherein the hover-over is overlaid a map based interface
E9. The method of claim E8, wherein the hover-over was accessed by means of pinch to zoom.
E10. The method of claim E8, wherein the hover-over is over a series of clustered points.
F1. A method for introducing the concept of non-linear content, the method comprising: a graphical, interactive user-interface object with which a user interacts in order to navigate the device; and is layered on top of a graphical map interface.
F2. The method of claim F1, wherein the moving comprises movement along any desired path.
F3. The method of claim F1, wherein the moving comprises movement along a predefined channel from the first predefined location to the predefined content region.
F4. The method of claim F1, further comprising displaying visual cues to communicate a direction of movement.
F5. The method of claim F4, wherein the visual cues comprise text.
F6. The method of claim F4, wherein said visual cues comprise an arrow indicating a general direction of movement.
F7. The method of claim F1, in which interaction is the real movement of a physical body.
F8. The method of claim F1, in which a user can zoom in for content discovery
F9. The method of claim F1, in which a user can zoom out for content discovery
F10. The method of claim F1, where content is clustered together, and the most relevant content is presented algorithmically present.
F11. The method of claim F1, where content is clustered together, and the highest ranked user content is presented first.
G1. A method for introducing the concept of hover states to touch-sensitive mobile devices, the method comprising: detecting a contact with the touch-sensitive display at a undetermined point; continuously moving the cursor on the touch-sensitive display in accordance with movement based on continuous contact with the touch screen is maintained, wherein the cursor is a graphical, interactive user-interface object with which a user interacts in order to navigate the device; and triggering a preview of the content that the cursor landed on, this content can be audio, video, text or any combination of these mediums.
G2. The method of claim G1, wherein the moving comprises movement along any desired path.
G3. The method of claim G1, wherein the moving comprises movement along a predefined channel from the first predefined location to the predefined content region.
G4. The method of claim G1, further comprising displaying visual cues to communicate a direction of movement.
G5. The method of claim G4, wherein the visual cues comprise text.
G6. The method of claim G4, wherein said visual cues comprise an arrow indicating a general direction of movement.
G7. The method of claim G1, wherein the PIP is over a batch of clustered points
G8. The method of claim G1, wherein the PIP is overlaid a map based interface
G9. The method of claim G7, wherein the PIP was accessed by means of pinch to zoom.
G10. The method of claim G7, wherein the PIP is over a series of clustered points.
H1. A method for applying a pinch-gesture on a touch sensitive display.
H2. The method of claim H1, wherein the unprojection from the display is made into the orientation of virtual camera in a virtual space containing digital content.
H3. The method of claim H1, wherein the unprojection vector defines the orientation of movement and the velocity of movement is defined as a function of the gesture.
H4. The method of claim H1, wherein digital content is translated within the virtual environment using the negated vector from claim 3, thereby allowing user to effectively “visit” each piece of content.
H5. The method of claim H1, wherein the entire digital realm zooms in.
H6. The method of claim H1, wherein the entire digital realm zooms out.
H7. The method of claim H1, wherein one piece of content zooms in.
H8. The method of claim H1, wherein one piece of content zooms out.
H9. The method of claim H1, wherein multiple selected piece of content zoom in.
H10. The method of claim H1, wherein multiple selected piece of content zoom out.
J1. A mechanism for distributing a scaled range of digital points based on the points a user has already accrued both via social capital and skill based games, the system comprising:
   a memory arranged for storing computer program instructions;
   an interface comprising a touch-sensitive display, wherein the point scale is a graphical, interactive user-interface object with which a user interacts in order to choose points;
J2. The system of claim J1, wherein the distribution comprises giving negative point.
J3. The system of claim J1, wherein the distribution comprises the ability to purchase points.
J4. The system of claim J1, wherein the distribution further comprise being awarded points.
J5. The system of claim J1, wherein said actions can be done both online and offline, and any other means of wired connectivity.
J6. The system of claim J6, wherein said actions can be done wired, wirelessly, or by any means of wavelength connectivity.
K1. A method for casting a virtual ray in the orientation of a physical device camera.
K2. The method of claim K1, wherein the casted ray is invisible.
K3. The method of claim K1, wherein the casted ray is hit-tested for digital content in real-time.
K4. The method of claim K1, wherein each hit-test for digital content returns a hit-result or none.
K5. The method of claim K1, wherein a hit-result identifies a unique piece of digital content.
K6. The method of claim K1, wherein a hit-result causes the digital content it identifies to respond with dynamic behavior.
K7. The method of claim K1, wherein the casted ray is hit-tested for physical content in real-time.
K8. The method of claim K1, wherein each hit-test for physical content returns a hit-result or none.
K9. The method of claim K1, wherein a hit-result identifies a unique piece of physical content.
K10. The method of claim K1, wherein a hit-result causes a digital augmentation to the physical it identifies to respond with dynamic behavior.
K11. The method of claim K1, wherein a hit-result causes audio, visual and haptic feedback.
L1. A method for creating a real-time stream of events characterizing the state of digital content that multiple users are interacting with.
L2. The method of claim L1, wherein digital content in a virtual world are accessible to multiple users in real-time.
L3. The method of claim L1, wherein multiple users can interact with said content in real-time.
L4. The method of claim L1, wherein each user in the virtual space is embodied by some virtual representation.
L5. The method of claim L1, wherein users can interact with the virtual embodiments of other users.
M1. A method for assigning ownership or tenancy of a virtual space along with ownership or tenancy to the virtual “air space”.
M2. The method of claim M1, wherein ownership or tenancy is designated from a map based interface that can be panned around in 2D space or from a 3D virtual space corresponding to real world coordinate space.
M3. The method of claim M1, wherein tenancy exists for a finite period of time. Once tenancy expires, the owner is free to lease the virtual space to the another tenant.
M4. The method of claim M1, wherein air space is described as the 3D extrusion of the virtual space on the real world coordinate system along the vector opposite the gravity vector.
M5. The method of claim M1, wherein the ownership or tenancy of virtual space includes ownership or tenancy of its corresponding air space.
M6. The method of claim M1, wherein a contract is provided by the overarching system to an owner or from an owner to another owner or tenant specifying the terms of ownership or tenancy.

1-59. (canceled)

60. A mobile communications device comprising:
a memory arranged to store a content map, the content map including a plurality of content objects, each content object being associated with a set of digital content, the memory storing one or more sets of the digital content;
a communications module, the communications module configured to communicate with at least one content server via a data network; and
a user interface comprising a display, the user interface arranged to i) display a first portion of the content map including a first content object and first set of digital content associated with the first content object, wherein the first content object is displayed in a first location on the displayed first portion of the content map, ii) receive a user input and send the user input to a processor, and, iii) in response to the processor, display a second portion of the content map, the second portion of the content map including a second content object and second set of digital content associated with the second content object, wherein the second content object is displayed in a second location of the displayed second portion of the content map; and
the processor arranged to control operations of the memory, communications module, and user interface, the processor further arranged to receive the user input from the user interface, process the user input, and, in response, instruct the user interface to display the second portion of the content map and second set of digital content.

61. The device of claim 60, wherein the user interface displays the content map as a content layer having the plurality of content objects laid over the content layer.

62. The device of claim 60, wherein the processor, in response to the user input, i) determines if the second set of digital content is stored in the memory and, if not, sends a request, via the communications module, to the at least one content server, to receive the second set of digital content, ii) receives the second set of digital content via the communications module, and iii) stores the second set of digital content in the memory for display via the user interface.

63. The device of claim 60, wherein the user interface enables a second user input to select one or more of the plurality of content objects.

64. The device of claim 63, wherein the second user input is via a moveable cursor enabling selection of a content object.

65. The device of claim 63, wherein the processor, in response to the second user input, i) determines if the second set of digital content is stored in the memory and, if not, sends a request, via the communications module, to the at least one content server, to receive the second set of digital content, ii) receives the second set of digital content via the communications module, and iii) stores the second set of digital content in the memory for display via the user interface.

66. The device of claim 60, wherein the processor, in response to the user input, determines that the second set of digital content is stored in the memory and instructs the user interface to display the second set of digital content from the memory.

67. The device of claim 60, wherein the processor fetches content associated with a data object that is closest to a cursor laid over a displayed portion of the content map.

68. The device of claim 60, wherein the displayed first portion of the content map includes a portion of the content map proportional to physical dimensions of the display.

69. The device of claim 60, wherein the user input includes a panning instruction.

70. The device of claim 69, wherein the panning instruction includes a user swiping a portion of the display in two-dimensional direction.

71. The device of claim 60, wherein the displayed second portion of the content map includes one or more content objects within the displayed first portion of the content map.

72. The device of claim 60, wherein at least one of the first set of digital content and the second set of digital content is presented in a region of the display.

73. The device of claim 72, wherein the region of the display includes a picture-in-picture (PIP) window overlaid on the displayed portion of the map content.

74. The device of claim 60, wherein the user input comprises physical movement of the mobile device.

75. The device of claim 74, wherein the movement comprises movement along a predefined channel from a first predefined location to a predefined content region.

76. The device of claim 60, wherein the display is configured to present at least one visual cue to communicate a direction of movement.

77. The device of claim 60, wherein the content map includes a map overlaid in a display including at least one of augmented reality (AR), virtual reality (VR), three dimensional (3D) imaging, and mixed reality (MR) imaging.

78. A data content server comprising:
a communications module arranged to, via a data network, receive a request for a first set of digital content associated with a first content object from a first mobile communications device of a plurality of mobile communication devices and send the first set of digital content to the first mobile communications device, the request including an identifier of the first mobile communications device, a location of the first mobile communications device, an identifier of the first content object;
a data store arranged to store a plurality of content objects and a plurality of sets of digital content associated with the content objects, each set of the plurality of sets of digital content being associated with at least one of the plurality of content objects, the data store maintaining a list of identifiers of the one or more mobile communications devices authorized to access the content server, a list of identifiers of a plurality of content objects, and a table associating each of the content object identifiers with at least one set of digital content of the plurality of sets of digital content, and for each mobile communications device, the data store being arranged to store a content map, the content map associated with the first mobile communications device including content objects associated with the first mobile communications device, the content objects associated with the first mobile communications device being arranged in relation to each other based on a ranking, wherein the ranking is based on at least one of a degree of relevance among the content objects, user selection, physical geographic proximity of a locations of content objects to a physical location of the first mobile communications device; and
a processor, in communication with the communications module and the data store, the processor arranged to process the request for the first set of digital content including i) authorizing access by the first mobile communications device to the content server by matching the identity of the first mobile communications device with one of the authorized mobile communications device identities in the data store, ii) matching the identifier of the first data object with a stored identifier of the first data object to determine the first set of digital content associated with the first data object, iii) sending the first set of digital content to the first mobile communications device via the communications module;
wherein, upon request from the first mobile communications device, the processor sends, via the communications module, the content map associated with the first mobile communications device to the first mobile communications device.

79. A mobile data system comprising:
a data network including one or more content servers and one or more mobile communications devices;
a first content server arranged to store a plurality of content objects and a plurality of sets of digital content associated with the content objects, each set of the plurality of sets of digital content being associated with at least one of the plurality of content objects, and for each of the one or more mobile communications devices, the first content server being arranged to store a content map, wherein the content map associated with the first mobile communications device includes content objects associated with the first mobile communications device;
the first mobile communications device, in communication with the first content server via the data network, including:
a memory arranged to store the content map, the content objects associated with the first mobile communications device, and the sets of the digital content associated with the content objects; and
a user interface comprising a display, the user interface arranged to i) display a first portion of the content map including a first content object and first set of digital content associated with the first content object, wherein the first content object is displayed in a first location on the displayed first portion of the content map, ii) receive a user input and send the user input to a processor, and, iii) in response to the processor, display a second portion of the content map, the second portion of the content map including a second content object and second set of digital content associated with the second content object, wherein the second content object is displayed in a second location of the displayed second portion of the content map; and the processor further arranged to receive the user input from the user interface, process the user input, and, in response, instruct the user interface to display the second portion of the content map and second set of digital content.
